(19) United States
(12) Patent Application Publication
(10) Pub. No.: US 2010/0296443 A1
(43) Pub. Date: Nov. 25, 2010

(54) SYSTEM, METHOD AND APPARATUS FOR ROUTE-OPTIMIZED COMMUNICATION FOR A MOBILE NODE NESTED IN A MOBILE NETWORK

(75) Inventors: Jun Hirano, Kanagawa (JP); Mohana Dhamayanthi Jeyatharan, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/680,171

(22) PCT Filed: Sep. 25, 2008
(86) PCT No.: PCT/JP2008/002672

§ 371 Date: Mar. 25, 2010

(30) Foreign Application Priority Data
Sep. 28, 2007 (JP) 2007-254783

(51) Int. Cl. H04W 40/00

(52) U.S. Cl. 370/328

(57) ABSTRACT

When a mobile host or mobile router in nested mobile network is roaming in a domain with multiple mobility anchor points, if the mobile host or mobile router in the nested mobile network tree path chooses different mobility anchor points to derive its regional care-of address, routing sub-optimality may occur. To overcome such routing sub-optimality, this invention presents two main methods. The first method is where the mobile router detects that a downstream node in its tree path has derived a regional care-of address from another mobility anchor point, and will make appropriate on-demand duplicate registration at the other mobility anchorpoint. The second method is such that the mobile router informs its own mobility anchor point of other mobility anchor point addresses, so that the mobile router's mobility anchor point will pass the location entries of the mobile router to the other mobility anchor points.

### TECHNICAL FIELD

This invention relates to the field of telecommunications in a packet-switched data communications network. More particularly, it concerns providing an optimized route to a mobile node having an end-to-end route optimization protocol and hierarchical mobility management protocol implemented.

### BACKGROUND ART

Many devices today communicate with each other using the Internet Protocol version 6 (IPv6). In order to provide mobility support to mobile devices, the Internet Engineering Task Force (IETF) has developed the “Mobility Support in IPv6 (MIPv6)” [Non Patent Citation 1]. Mobility support is done in [Non Patent Citation 1] with an introduction of an entity at the home network known as a home agent (HA). Mobile Nodes (MNs) register their care-of addresses that they obtain in foreign links with the home agents using messages known as Binding Updates (BU). The above-mentioned BU allows the home agent to create a binding between the home address, which is the long-term address obtained in the home link, and care-of address of the mobile node. The home agent is responsible to intercept messages that are addressed to the mobile node's home address (HoA), and forward the packet to the mobile node's care-of address using packet encapsulation (i.e. putting one packet as the payload of a new packet, also known as packet tunneling). In addition, MIPv6 also specifies a route optimization (RO) method when communicating with a correspondent node (CN). This RO mechanism allows the MN to perform a validated registration of its care-of address at CN so that MN and CN can communicate with each other using MN's care-of address, without having to go through MN's home agent. CN obtains a validated registration of MN's care-of address by means of Return Routability (RR) test that is initiated by MN. This Return Routability test provides a proof to the CN that the care-of address of MN is collocated with MN's home address. This RO mechanism is an optional mechanism and its benefits are obtained only when the CN has some functionality to support RO mechanism.

One problem with MIPv6 is that for a single change in network attachment, the MN needs to update one or more of its home agents and one or more of its correspondent nodes. This increases the signaling load injected into the network for fast moving MN. Moreover, the average hand-off establishment time with CN per change in network attachment is high as every single change in network attachment involves transmission of RR and BU messages. Thus, during a session associated with a flow or connection, considerable amount of time is allocated to hand-off establishment, which results in jitters and packet losses. Such jitters are detrimental for applications such as voice over IP (VoIP), multimedia and video streaming and packet losses are detrimental for flows that carry critical text information. Furthermore, packet losses decreases transmission control protocol (TCP) throughput when TCP is used for information critical data applications.

To address such issues of MIPv6, IETF has standardized a protocol called the hierarchical mobility management protocol version 6 (HMIPv6) disclosed in [Non Patent Citation 2]. HMIPv6 uses two types of care-of addresses and a new node called the Mobility Anchor Point (MAP). The basic principle is that the MN derives two care-of addresses at a new network it is attached to. One of the care-of addresses is called the Local care-of address (LCoA) which is the address obtained from the network MN is directly attached to. The other address is called the Regional care-of address (RCoA) and it is derived from the MAP's home network prefix. The RCoA is the address the MN will use as the care-of address when communicating with CN and HA. Since MAP is preferably a fixed router placed higher up in the routing hierarchy, this RCoA does not change often. As long as the roaming MN is inside the network segment where the MAP information such as the MAP address embedded in a MAP option can be obtained, Regional care-of address does not change. In this protocol, for every change in network attachment, the hand-off establishment procedure is mostly with the MAP where the LCoA is registered. Only when the MN moves out of the MAP and hence the RCoA is changed, will there be simultaneous updates or hand-off establishments to MAP, CNs and HAs. Thus, on average, signaling load into network per change in network attachment is much less when compared to pure MIPv6. Furthermore, for every change in network attachment, the hand-off establishment time is less on average. This is because, majority of the time, hand-off is only associated with a simple LCoA registration at MAP which is placed at close proximity to the roaming MN. Thus the complexities such as jitters and packet losses discussed previously are much less here. This protocol is an accepted standard for nodes that want power saving for its flows and for nodes that carry flows that require stringent QoS parameters.

With the ever-increasing proliferation of wireless devices, it is foreseeable that a new class of mobility technology will emerge: network mobility, or NEMO, where a whole network of nodes changes its point of attachment in entirety. The IETF has developed a solution for basic network mobility support disclosed in [Non Patent Citation 3]. Here, it is specified that the mobile router (MR) when sending BU to home agent, will specify the network prefix, which the nodes in the mobile network are using. The above mentioned network prefix are specified using special options known as Network Prefix Options to be inserted into the BU. These allow the home agent to build a prefix-based routing table so that the home agent will tunnel any packets sent to destinations with these prefixes to the care-of address of the mobile router.

When a MN is deeply nested in a NEMO, two types of problems arise. The first type of problems includes overhead of multiple encapsulations and suboptimal routing for data packets. This is due to nested tunneling for the nested NEMO scenario. Multiple encapsulations results in delay of data packet due to the increase in packet size and may also further lead to packet fragmentation. Packet fragmentation may further result in data packet loss. Suboptimal routing also leads to data packet delay, increase in network load and burdening the HAs with higher processing load.

The second type of problems includes the massive delay for layer three hand-off establishments for the deeply nested MN and the high signaling load injected into the network due to signaling overhead of RR and BU stream. This arises because when MN is deeply nested and if there is a change in network attachment, the new care-of address obtained has to be registered at the CNs or HAs. There will be a massive delay in such registration due to the packets involved in hand-off registration being subjected to multiple encapsulations and also traversing through pinball routing path comprising of all upstream MRs and their home agents. As discussed previously, this increase in hand-off delay time will contribute significantly to the overall session or connection time of a flow carried by a fast moving MN, which results in jitters and packet losses. Furthermore, excessive hand-off establishment signaling by a MN during a given time affects other flows carried in the network as well.

To solve the first type of problems, there have been various proposals to what is known as a nested tunnel optimization in the relevant field of art. Particularly, [Non Patent Citation 4] discloses a solution known as the Access Router Option (ARO). This new option, called the Access Router Option, is used by the sender (i.e. mobile router or mobile host) to inform the recipient (e.g. home agent or correspondent node) the primary global address of the access router the sender is directly attached to. After sending the binding update message with the access router option, the mobile node can then insert a special signal called the “direct-forwarding-request” signal to the data packet it sends out. This signal will cause upstream mobile routers to send their own binding updates to the destination address. This process is repeated until an access router (which usually is the fixed router of the access network) is reached that does not understand the “direct-forwarding-request” signal. With all upstream mobile routers sending binding updates to the destination, the destination can build a chain of mobile routers the mobile node is attached to. This can be used to construct the extended Type 2 Routing Header (RH2), so that when the destination node wants to send a packet back to the mobile node, it can embed the packet with the routing header, and the packet will be routed directly to the mobile node via the chain of mobile routers. This method is considered as an adequate method to provide end-to-end route optimization without trading off security.

To solve the second type of problems and to partially solve the first type of problems, [Non Patent Citation 5] reveals a scheme which tackles issues such as nested tunneling and Layer three (L3) hand-off establishment delay. This scheme attempts to improve hand-off efficiency and signaling overhead and provide reasonable end-to-end route optimization for a nested MN in a MAP environment. In this scheme, every MN behaves as specified in HMIPv6. For every change in local network attachment, the MN will update its LCoA at the MAP and for every change in the RCoA or the MAP domain, the MN will update its CNs and HAs of the new RCoA. In this scheme, it is also assumed that the MR will operate as specified in the HMIPv6 protocol for the MN but will have slight modifications. The MR when operating in the router mode will advertise the MAP option in its router advertisement (RA) to extend the MAP services to the MNs and MRs that are attached to it. Furthermore, in order to help the MAP trace the optimum path to reach a MN LCoA, the MRs will do a prefix scoped binding update (PSBU) at the MAP instead of the pure HMIPv6 type of registration. Suppose the MN is deeply nested behind some number of MRs, the binding cache at the MAP will have MN's LCoA and RCoA as well as the upstream MRs' LCoAs, RCoAs and prefixes. It should be well known to one skilled in the art how the MAP can use this prefix to locate all the LCoA associated with the MN's upstream MRs. Such tracing is possible because the MN's or MR's LCoA is derived from its access router's prefix.

When a data packet arrives at the MAP where the destination address is RCoA associated with the MN, MAP will first locate this RCoA in its binding cache (BC). Then the MAP will find the corresponding LCoA associated with this RCoA in the binding cache entry (BCE). Following that the MAP will search for the prefix that matches this LCoA of MN. By doing this, MAP can find the location parameters of the direct mobile router of MN and repeat such process until all the upstream MRs LCoAs can be obtained. Once such recursive tracing is done at the MAP, it will tunnel the data packet to the MN by inserting a routing header in the tunnel consisting of the all-upstream MRs LCoAs. When MN sends a packet to the CN, as in HMIPv6, MN will first encapsulate the packet in a tunnel to the MAP. All the upstream MRs of MN, since it has a binding at the MAP, will further encapsulate the packet in separate tunnels to the MAP. The final effect of this scheme is that for incoming data packets, there will be a single tunnel from MAP with extended routing header. For outgoing data packet there will be multiple encapsulations from MN/MR to MAP in the wireless domain. It is important to understand that this protocol mainly attempts to improve hand-off and signaling for a MN deeply nested in a NEMO. When comparing this scheme to the ARO scheme as disclosed in [Non Patent Citation 4], it is important to appreciate that the ARO scheme provides better end-to-end RO. This is because in ARO, there is no tunnel in the wireless domain in the reverse direction, whereas there are multiple tunnels in the wireless domain in [Non Patent Citation 5]. In addition, for ARO, there is no tunnel in the forward direction.

From the above discussions it can be foreseen that in the future, different types of protocols may need to be implemented in the system in order to achieve the objectives of data flows, end terminals and networks. As far as data flows are concerned, the main objective will be to reduce delay, jitters and packet loss. The main objective of the network perceived QoS is to reduce the network load or more correctly the signaling load into the network. The MN's objective is to save power. Hence in order to combine all these objectives as a single goal, it is very likely that multiple protocols may need to be implemented in the system. A future MN may need to support different types of flows having different QoS needs. For example, the MN may carry some flows that require strict end-to-end RO and also some flows that are not strict about end-to-end RO. For flows that are not too strict about end-to-end RO the MN may need to consider improving signaling load injected into network and save power by reducing frequent binding updates. Thus, it is foreseeable that in the future different type of protocols needs to be implemented in a MN, MR, some key routers and CN.

In the future, there may be a case where both ARO protocol and some HMIPv6 related protocol (pure HMIPv6 or HMIPv6 with some RO) implemented in MNs and MRs. Furthermore, such heterogeneous protocols implementing nodes may possibly be roaming in localized mobility management domains that could possibly have a plurality of Mobility Anchor Points or Localized Mobility Management Anchors (LMAs). The above-mentioned LMA is a well-defined terminology in the Network based Localized Mobility Management (NetLMM) IETF working group and it could possibly have a MIPv6 home agent functionality or a HMIPv6 MAP functionality. A detail description of LMA can be found in [Non Patent Citation 6]. When a nested NEMO is roaming in a NetLMM domain with above mentioned heterogeneous protocols implemented, non of the MNs and MRs in the nested NEMO would know the localized mobility management functionality available in the architecture and all the MNs and MRs in the nested NEMO will not trigger the HMIPv6 related stack and may only use ARO mechanism to communicate with CNs. In non-NetLMM domain, but in a domain where there are MAPs available, the nested NEMO MNs and MRs with the above mentioned heterogeneous protocols will trigger ARO and/or HMIPv6 related stacks according to the QoS needs of the flows, the power state of the MN/MR and the traffic state of the network. The traffic state of the network implies the network bandwidth utilization state or network congestion state.

In the above said local mobility management domain with plurality of MAPs, it is further assumed that all these MAPs have the same HMIPv6 functionality as the roaming MNs and MRs. Basically; this means that all the MAPs in the domain have the same HMIPv6 RO functionality. The above said HMIPv6 RO functionality can be ARO enabled HMIPv6 functionality, prefix delegation based HMIPv6 functionality as briefly mentioned in [Patent Citation 3] or PSBU based HMIPv6 functionality as disclosed in [Non Patent Citation 5].

The above mentioned ARO enabled HMIPv6 functionality is such that the MAP is similar to a pure HMIPv6 MAP where it gives its home address as the MAP option so that MNs and MRs can derive RCoA from this address prefix and perform local registrations at the MAP. Furthermore, this ARO enabled HMIPv6 MAP also supports addresses that are sent as ARO option in local binding update and will carry out similar ARO based tracing as outlined in [Non Patent Citation 4]. The parameters sent to the MAP in the ARO option can be the mobile access router's home address or the mobile access router's regional care-of address. The tracing at the ARO enabled HMIPv6 MAP will be for the RCoA associated with a MN or MR. All the LCoAs required to reach this RCoA optimally is traced by using single or multiple ARO parameter registered at the MAP. More explanation on this will be given in other sections of this document.

The above mentioned prefix delegation based HMIPv6 functionality is such that the MAP is RO enabled and it will delegate prefixes to the MRs upon request and the MRs will perform a local PSBU with the MAP using this delegated prefix in the prefix option. It is further assumed that MNs and MRs that are attached to a MR will use this MAP delegated prefix to derive its LCoA. The MAP accepts this above mentioned local PSBU straight away and there is no need for the MAP to perform a collocation test between RCoA, LCoA and the prefix as this prefix was assigned by the MAP itself. When a packet arrives at the MAP from CN, the MAP will initially look for the RCoA entry and find the corresponding LCoA. Then it will look for the prefix field matching the LCoA prefix. If the prefix entry is found then the tracing mechanism will look for the LCoA entry associated with the above found prefix and continue such searching until no more prefix matching is found. In an alternate manner, it can be said that when all the LCoAs associated with the upstream MRs of a particular MN/MR has been found, the tracing comes to an end.

The above-mentioned PSBU based HMIPv6 MAP functionality is such that the MRs perform PSBU at the MAP where the said prefix is given to the MR from its home network. In this case, the MAP may have to carry out a RCoA, LCoA and prefix collocation test before accepting this local PSBU. A detail explanation of this was given previously in this current document when explaining the [Non Patent Citation 5].

It is further assumed that the nested NEMO nodes with previously mentioned heterogeneous protocols are roaming in domains where there are multiple MAPs in the architecture. Multiple MAPs are usually implemented in a domain for load balancing purposes. For example, when there is a single MAP in the domain, and it is placed further up in the network architecture covering a large segment of the network, the local mobility management domain will be big and hence large number of MNs and MRs will want to use the MAP for local mobility management services. This will increase the load on the MAP. The MAP usually does Neighbor Discovery (ND) Proxy signaling for the RCoA values derived from its home link prefix by the MNs and MRs. This ND proxy signaling for large number of MNs and MRs drains a considerable amount of power from the MAP and increases the processing load. Furthermore, the single MAP needs to tunnel large number of packets coming to numerous RCoA values registered at the MAP, which further increases the processing load on the MAP. Moreover, when there are numerous nodes in the local mobility management domain and there is only a single MAP in the architecture, the BCEs at this single MAP will be exhaustive and the MAP will use quite a large chunk of its memory for its BCEs and hence waste MAP's resources. The single MAP is also subjected to heavy de-tunneling procedure for out going traffic, which also further increases the MAP's processing load. All these anomalies associated with a single MAP imply that such single MAP architectures are not favorable for local mobility management domains that want to house large number of MNs and MRs. If a single MAP is used then there is a high possibility of MAP failure when large number of nodes uses the MAP functionality. Thus it is clear that multiple MAPs in localized mobility domain or multiple LMAs in NetLMM Domain or multiple proxy home agents in the Proxy Mobile IP (PMIP) domain is required for load balancing. More details of PMIP and proxy home agents are discussed in [Non Patent Citation 7] and will be briefly discussed later in this document.

To alleviate all these problems just mentioned with a single MAP in the architecture, as outlined in [Non Patent Citation 2], it is quite common to deploy multiple MAPs. In [Non Patent Citation 2] it was outlined that these MAPs may possibly be deployed hierarchically in a domain. Hierarchy of MAP placement in a domain means there will be a single or plurality of root MAPs and also will possibly have n (n>1) number of tiers of MAPs tessellated in the domain. In an alternate deployment to the hierarchical way, all MAPs in the domain can be deployed at a single tier. There is no standard or mandatory way to deploy the multiple MAP architecture.

In the hierarchical MAP deployment, the MNs and MRs will receive MAP options associated with MAPs that are in their default routing path. In some cases, there can be more than one default routing path and thus numerous MAP options may be available to the MNs and MRs. When MNs and MRs are moving fast, they may choose MAPs that are further away so that the global registrations need not be performed often but the trade-off is that the tunnel from further away MAP to the end MN/MR is longer and hence subjected to more data packet delay. For slow moving MNs and MRs, the MAPs at lower tiers can be chosen. The advantage with lower tier MAPs is that the tunnel length is short. Furthermore, low-tiered MAPs are suitable for slow moving MNs and MRs because, the change of RCoA rate will not be too high and hence global registration frequency will be within desired limits. In [Non Patent Citation 2] there is no standard mechanism for load balancing among MAPs. One way is for the MAPs to, when it realizes that it is extremely overloaded, set the preference value to “zero” in its MAP option. In this case, the MN/MR MUST not use that MAP. Nevertheless, in all other instances any MAP can be chosen out of some number of MAPs available to a MN/MR. In the prior art [Non Patent Citation 2], the multiple MAP availability is revealed to a roaming MN/MR only and there is no prior analysis or work done for a roaming nested NEMO in a multiple MAP scenario. Next FIG. 1 is looked into where such an analysis is made and a route optimization problem is identified.

In FIG. 1, VMN 10 is directly attached to MR 20 and both these nodes are roaming in a Local Mobility Management domain 101 that has two MAPs, which are MAP 30 and MAP 31. The Local Mobility Management domain is connected to the Internet 100. It is further assumed in FIG. 1 that VMN 10 is having a data communication session with CN 50. The home agents of VMN 10 and MR 20 are HA 40 and HA 41 respectively. It is further assumed that MAP 30 and MAP 31 have ARO enabled HMIPv6 functionality described previously and the VMN 10 and MR 20 have ARO and pure HMIPv6 protocols implemented in them. It is also assumed that in addition to fixed access router (AR), MRs also relay all the MAP options it receives. In this scenario it is considered that MR 20 receives MAP 30 address and MAP 31 address in the RA MAP options it receives, and it further relays both the MAP options in its own RA. VMN 10 receives ARO option and both the above-mentioned MAP options. MR 20 only receives both the MAP options. It is assumed that VMN 10 chooses only the MAP 31 option to derive its RCoA and also process the ARO option. It can be understood by one skilled in the art that there is no major reason for VMN 10 to derive two RCoAs from the same MAP domain to communicate with CN 50. It is also assumed that MR 20 only process the MAP option (since it only receives MAP options) and it uses the MAP 30 option to derive its RCoA value. It is important to understand that VMN 10 and MR 20 can use any MAP in the local mobility management domain as long as its preference value given in the MAP option is above “zero”. In a non-hierarchical MAP architecture where the traffic demand is uniformly distributed in the domain, it is very likely that the MAP options received from MAP 30 and MAP 31 will have similar preference values because their usage will be of the same amount. In a hierarchical architecture when either MAP 30 or MAP 31 are higher up in the hierarchy, then it is likely that the MAP higher in the architecture will usually have a lower preference value because it may be slightly more overloaded or more used. Nevertheless, the MAP selection by VMN 10 and MR 20 is purely arbitrary and they can choose whatever MAP they want to use.

Once MR 20 processes the MAP 30 option, it will derive a RCoA value using the address prefix of MAP 30 and make a local registration at MAP 30. The above said registration values are shown by BCE 61 in FIG. 1. Following this registration, VMN 10 may make its local registration at its respective MAP, which is MAP 31. Since VMN 10 has processed both the ARO and MAP 31 options, VMN 10 will make local registration at its MAP 31 by attaching the ARO option. This ARO option will preferably have global home address of MR 20 in it. The above said registration at MAP 31 will create the first row of entries at BCE 62. When the MAP 31 sends an Acknowledgement (ACK) to the above said local registration, MAP 31 will source route this ACK to VMN 10 via home address of MR 20. This ACK packet will first reach MR 20 before being further routed to the LCoA of VMN 10. Once MR 20 receives this above-mentioned ACK, MR 20 will perform ARO registration at MAP 31. This registration will be the normal RR and MIPv6 registration as outlined in [Non Patent Citation 4] but using RCoA of MR 20 as the care-of address. The above said ARO registration values are shown by the second row of entries in BCE 62. It can be well appreciated by one skilled in the art that MR 20 will use its RCoA to perform ARO registration at MAP 31 because its HMIPv6 stack is triggered and its care-of address is thus its RCoA.

Once VMN 10 has completed local registration at its MAP 31, VMN 10 will perform appropriate global registration at its HA 40 and CN 50 respectively. It is assumed that VMN 10 carries out RR and then does MIPv6 based ARO registration at CN 50 but using its RCoA as its care-of address. The first row of entries in BCE 60 shows the VMN 10 global registration values. The third column in BCE 60 shows the ARO value given by VMN 10. CN 50 may possibly send an ACK to RCoA of VMN 10 by explicitly source routing the ACK via home address of MR 20. Once MR 20 receives the above said ACK from CN 50, it will send its appropriate ARO registration to CN 50 using its RCoA as its care-of address. The above said registration values are shown by the second row of entries in BCE 60.

When CN sends its data packet to VMN 10, the destination address will be set to RCoA of MR 20. Such a destination address setting is obtained by performing ARO tracing using the BCE 60. This packet will travel via path 120 and reach MAP 30 and then MR 20. Since MAP 30 has a route to RCoA of MR 20 the data packet sent from CN 50 will get further tunneled to LCoA of MR 20 at MAP 30. When MR 20 processes the packet reached via path 120, the next address to be reached will be RCoA of VMN 10 and it will be set by MR 20. Since MR 20 does not have a route to RCoA of VMN 10, the packet will be sent to RCoA of VMN 10 via MAP 30 and home agent of MR 20. These above mentioned paths are shown by path segments 121 and 122 respectively. At HA 41, when the packet traversed via path 122 is decapsulated, the destination will be found as RCoA of VMN 10 and the packet will be sent to MAP 31 where this above-mentioned RCoA was derived. MAP 31 has routing path to RCoA of VMN 10 as can be seen from BCE 62. The next hop to reach RCoA of VMN 10 will be RCoA of MR 20. Thus the packet will be further routed via the path 124 and reach MAP 30. At MAP 30, the route to reach RCoA of MR 20 is available and the packet will reach VMN 10 finally via MR 20 along the path 125.

One can clearly see that the CN 50 to VMN 10 routing path is very long-winded and sub-optimal. This long-winded ping-pong routing via MAPs occurs mainly due to the fact that the VMN 10 and MR 20 local registrations (LCoA registrations) are made at different MAPs. Basically, to trace all the LCoAs required to optimally reach a RCoA of a MN or MR that is attached to a nested NEMO, all the upstream MRs of the said MN or MR may preferably need to have some form of permanent or semi-permanent registrations at the MAP from which the above said RCoA is derived. Since in FIG. 1 the upstream MR of VMN 10 is attached to another MAP, which is different from the MAP of VMN 10, the RCoA of VMN 10 cannot be traced optimally at MAP 31. There is no MR 20 LCoA registration at MAP 31 and that is the root cause of such ping-pong routing between MAPs. Thus the packet had to be routed to and forth between MAPs and this causes excessive routing delays. Excessive routing delay is very detrimental to real time and time critical applications.

To further understand the above outlined routing problem in greater depth, FIG. 2 is looked at next. This figure shows in greater detail the routing sub-optimality problem that was shown in FIG. 1. FIG. 2 not only shows the routing delays but it more clearly shows the excessive tunneling associated with the scenario described in FIG. 1. When CN 50 wishes to send a data packet to HoA of VMN 10, BCE 60 (given in FIG. 1) will be traced using ARO mechanism and the addresses obtained from such tracing will be RCoA of MR 20 and RCoA of VMN 10. Thus, CN 50 will construct the data packet where the destination address will be set to RCoA of MR 20 and CN 50 will also insert a RH2 where the address in this routing header will be RCoA of VMN 10 and HoA of VMN 10 as shown by packet structure 208 in FIG. 2. This packet 208 will be routed via the Internet and reach MAP 30 from which the RCoA of MR 20 was derived. The routing path from CN 50 to MAP 30 is shown by 200 in FIG. 2. MAP 30 will intercept this packet 208 and will look for appropriate route for the destination address, which is RCoA of MR 20. Since MAP 30 has a route to RCoA of MR 20, it will encapsulate the packet 208 in a tunnel and the encapsulated packet is shown by 209 in FIG. 2. It can be seen that the tunnel header will have source address set to MAP 30 address and the destination address set to LCoA of MR 20. This encapsulated packet at MAP 30 will travel via the path 201 and will reach the destination address, which is LCoA of MR 20.

MR 20 will decapsulate the packet 209 and will realize the packet is destined to itself (inner packet destination address is RCoA of MR 20). In such a case, MAP 30 will further inspect the packet by looking at the RH2 and will note that the next address is RCoA of VMN 10. MR 20 will then set the destination address of the packet to RCoA of VMN 10 and put the RCoA of MR 20 in the RH2. The innermost packet in packet 210 shows this said packet construction. MR 20 does not have any route to RCoA of VMN 10 and thus to overcome ingress filtering, MR 20 will encapsulate the packet in two tunnels. The immediate tunnel will be to its home agent, which is HA 41, and the outermost tunnel will be to its MAP, which is MAP 30. This doubly encapsulated packet 210 will be first sent via path 202 to MAP 30. There the outermost tunnel will be removed and the packet with single level of encapsulation will be further routed via the path 203 to HA of MR, which is HA 41.

At HA 41 the single tunnel will be completely removed and the innermost packet will finally reach MAP 31. The fully decapsulated packet at HA 41 will be destined to RCoA of VMN 10 and thus it will travel via path 204 and will be intercepted by MAP 31. MAP 31 using the BCE 62 as given in FIG. 1 will find the tunnel routing header related addresses. By using ARO tracing using the above said BCE 62 entries, the following tunnel addresses will be obtained. They are RCoA of MR 20 and LCoA of VMN 10. This is shown in the packet 211. The tunnel destination address will be set to RCoA of MR 20 and the tunnel RH2 will have LCoA of VMN 10 as shown in 211. This encapsulated packet will travel via the path 205 and will be intercepted by MAP 30. MAP 30 will inspect the packet 211 and will first look at the destination address. Since the destination address is RCoA of MR 20 and furthermore it has a route to RCoA of MR 20, MAP 30 will further encapsulate the packet in a tunnel. This doubly encapsulated packet is given by 212 in FIG. 2. The destination address of the outermost tunnel associated with packet 212 is LCoA of MR 20 and thus packet 212 will reach MR 20 via path 206. At MR 20, the packet will be decapsulated once. After eliminating the outermost tunnel, MR 20 will again come across that the destination is set to RCoA of MR 20. In that case it will inspect the RH2 and will find the LCoA of VMN 10 there. In that case it will change the destination address to LCoA of VMN 10 and further route the packet 213 via path 207. At VMN 10, the packet 213 will be fully decapsulated and processed by VMN 10.

It can be clearly seen from FIG. 2 that the routing paths comprising of path segments 200-207 is clearly sub-optimal. Moreover, it can be seen from FIG. 2 that this sub-optimal routing path has been further subjected to multiple level of encapsulations. Thus the average packet size is considerably high when compared to the packet 208 that originated at CN 50. All these leads to excessive delays and lot of processing burden associated with routers doing encapsulation and decapsulation procedures.

Patent Citation 1: Hirano, J., Ng, C. W., et al., “Method and Apparatus for controlling packet forwarding, and communication node”, WIPO Patent Application Publication WO06129863A1, December 2006.
Patent Citation 2: Hirano, J., Ng, C. W., et al., “Method and Apparatus for controlling packet forwarding”, WIPO Patent Application Publication WO06129858A1, December 2006.
Patent Citation 3: Hirano, J., Ng, C. W., et al., “Method and Apparatus for controlling packet forwarding”, WIPO Patent Application Publication WO06129855A1, December 2006.

### Non Patent Citation 1: Johnson, D. B., Perkins, C. E., and Arkko, J., “Mobility Support in IPv6”, Internet Engineering Task Force Request For Comments 3775, June 2004.

### Non Patent Citation 2: Soliman, H., et. al., “Hierarchical Mobile IPv6 Mobility Management (HMIPv6)”, Internet Engineering Task Force (IETF) Request For Comments (RFC) 4140, August 2005.

### Non Patent Citation 3: Devarapalli, V., et. al., “NEMO Basic Support Protocol”, Internet Engineering Task Force Request For Comments 3963, January 2005.

Non Patent Citation 4: C. Ng and J. Hirano, “Securing Nested Tunnels Optimization with Access Router Option”, IETF Internet Draft: draft-ng-nemo-access-router-option-01.txt, Jul. 12, 2004.
Non Patent Citation 5: Ohnishi, H., Sakitani, K., and Takagi, Y., “HMIP based Route Optimization Method in Mobile Network”, IETF Internet Draft: draft-ohnishi-nemo-ro-hmip-00.txt, October 2003.
Non Patent Citation 6: Bedekar, A., et al., “A protocol for Network-based Localized Mobility Management” IETF Internet Draft: draft-singh-netlmm-protocol-00.txt, Dec. 5, 2006.
Non Patent Citation 7: Gundavelli, S., et al., “Proxy Mobile IPv6” IETF Internet Draft: draft-sgundave-mip6-proxymip6-01.txt, Jan. 5, 2007.

### DISCLOSURE OF INVENTION

From prior discussions, it can be understood that, for large local mobility management domains it is essential that this domain have many MAPs for load balancing purposes. In such a case, MNs or MRs in nested NEMO should preferably receive all the MAP addresses that are in their default routing path to support load balancing among the MAPs. If such a design is incorporated for load balancing purposes, then as seen in the prior problem analysis there is a possibility for the MN/MR and its upstream MRs to end up choosing different MAPs to derive its RCoA and make local registrations. When different MAPs are chosen among MNs and MRs in the nested NEMO tree path, and the above said MN or MR in nested NEMO does global MIPv6 registration with CN using RCoA, there will be definite routing sub-optimality as described previously.

It is thus an objective of the present invention to overcome or at least substantially ameliorate the afore-mentioned disadvantages and shortcomings of the prior art. Specifically, there are two objectives of the present invention in such an ARO and HMIPv6 heterogeneous scenario when there are multiple MAPs in the architecture. The first objective is to provide MN or MR nested in a NEMO, local mobility management services as well as obtain optimal routing with CN without trading-off the load-balancing objective of the multi MAP scenario. Basically, the above said objective is such that the above said MN/MR should ideally configure its RCoA only from one MAP out of some n number of MAPs available and yet, eliminate route sub-optimality issues. The second objective is to enable the above said route optimization in a multiple MAP scenario without excessive signaling via the wireless domain or without excessive signaling in the local mobility management network domain.

In order to achieve the foregoing object, according to the present invention, the following systems, methods and apparatuses are provided.

The present invention provides a system of communications node comprising of VMNs, MRs, MAPs, HAs and CNs where it is considered that the said VMNs and MRs have ARO and some HMIPv6 RO enabled protocols implemented in them. It is further considered in this system there are a plurality of MAPs in the local mobility management domain architecture, where the said MAPs have some HMIPv6 RO functionality implemented similar to the said VMNs and MRs. In such a system, MR in nested NEMO will make a registration at the MAP of its down stream MRs and VMNs in the nested NEMO tree path, irrespective of the MAP it is attached to. This said alternate duplicate registration at other MAP is done without configuring a new regional care-of address from other MAP.

The present invention provides a system of communications node comprising of VMNs, MRs, MAPs, HAs and CNs where it is considered that the said VMNs and MRs have ARO and some HMIPv6 RO enabled protocols implemented in them. It is further considered in this system there are a plurality of MAPs in the local mobility management domain architecture, where the said MAPs have some HMIPv6 RO functionality implemented similar to the said VMNs and MRs. In such a system, MR in nested NEMO will have information on all the MAP options available to its nested NEMO tree path MNs and MRs and thus attach the other MAP addresses in its local binding update to its chosen MAP. It is further considered that all MNs and MRs in the nested NEMO tree path will attach to one MAP out of some number of MAPs available to the nested NEMO.

According to the present invention, methods and apparatuses used by each of all nodes in the above systems are also provided.

The present invention has the advantage of providing a useful mechanism in an ARO and HMIPv6 heterogeneous environment.

### BRIEF DESCRIPTION OF THE DRAWINGS

FIG. 1 shows the network diagram of an ARO and HMIPv6 integration scenario when prior art protocols are deployed and there are multiple MAPs in the architecture.

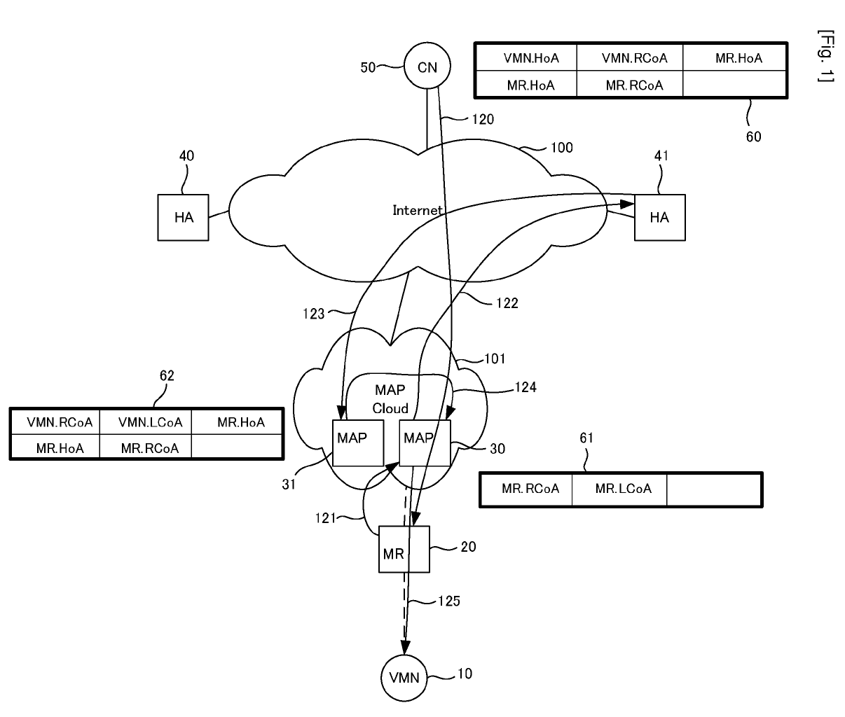

FIG. 2 shows the message sequence chart of the CN to VMN data traffic in the same prior art scenario disclosed in FIG. 1.

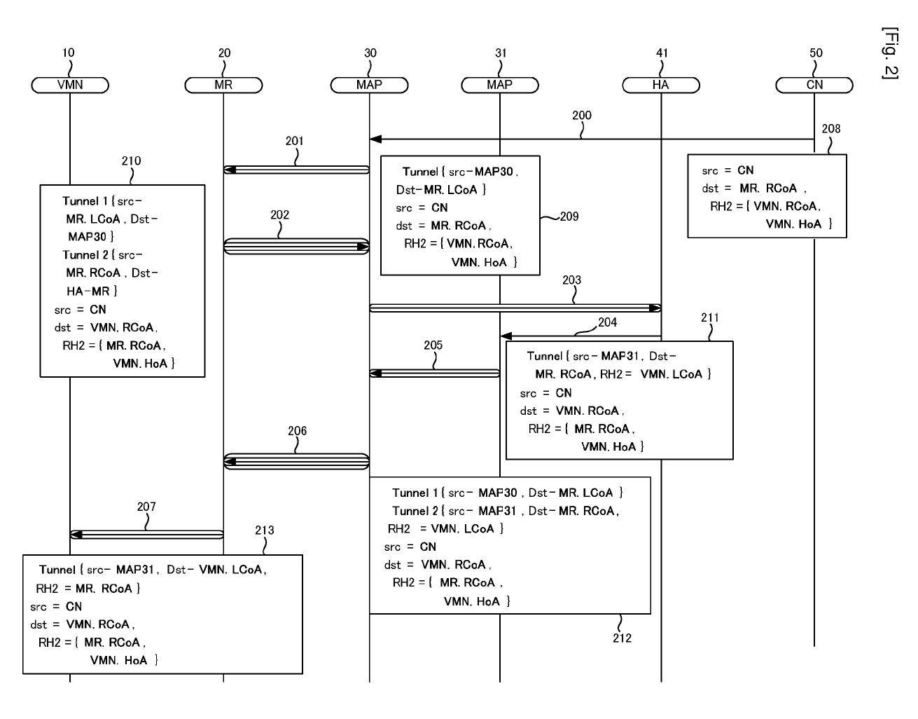

FIG. 3 shows the message sequence chart of the first main invention where a MR makes appropriate registration at the other MAP according to a preferred embodiment of the present invention.

FIG. 4A shows the network diagram of the main invention disclosed in FIG. 3, in cases where the MAPs have RO mechanisms that are different from that given in FIG. 3 according to a preferred embodiment of the present invention.

FIG. 4B gives the functional architecture of MR explained in FIG. 3 and FIG. 4A according to a preferred embodiment of the present invention.

FIG. 4C shows the flow chart associated with MR operation in FIG. 3 and FIG. 4A according to a preferred embodiment of the present invention.

FIG. 5A shows the network diagram of the second main invention where MAP-to-MAP location registration content transfer is done with the support of the terminal according to a preferred embodiment of the present invention.

FIG. 5B gives the functional architecture of MAP explained in FIG. 5A according to a preferred embodiment of the present invention.

FIG. 5C shows the flow chart associated with MAP operation in FIG. 5A according to a preferred embodiment of the present invention.

FIG. 6 shows the network diagram of a variation of the main invention where the MR makes a decision on MAP options transmission according to a preferred embodiment of the present invention.

FIG. 7 shows the network diagram of another variation of the main invention where MAP-to-MAP location registration content transfer is done according to a preferred embodiment of the present invention.

FIG. 8 shows the network diagram of NetLMM scenario where LMA to LMA location registration content transfer takes place for load balancing purpose according to a preferred embodiment of the present invention.

FIG. 9 shows the network diagram of NetLMM scenario where LMA to LMA location registration content transfer takes place for reliability purpose according to a preferred embodiment of the present invention.

FIG. 10 shows the network diagram of NetLMM scenario where Mobility Access Gateway (MAG) attaches with the other LMA for link failure condition according to a preferred embodiment of the present invention.

### BEST MODE FOR CARRYING OUT THE INVENTION

The present invention presents two main approaches. The first approach is such that, in order to provide local mobility management based route-optimization (i.e. using RCoA as care-of address to CN) to a MN/MR that is in nested NEMO, without violating the load balancing principle in a multiple MAP scenario, when a MR realizes that its downstream MN/MR is attached to another MAP which is different from its own, it will make an appropriate location registration at the other MAP. By MR doing so, semi-permanent registrations are created at the other MAP until the down stream MN/MR moves out from the above said MR's NEMO. Moreover, load balancing is achieved because another RCoA at the other MAP is not derived by the said MR to solve the route sub-optimality issue. If another RCoA is derived from the other MAP, then the other MAP may have to do ND-Proxy signaling for this address and thus increase the load on the above said other MAP.

The second approach is such that, again, in order to provide local mobility management based route-optimization (i.e. using RCoA as care-of address) to a MN/MR that is in nested NEMO, without violating the load balancing principle in a multiple MAP scenario, the above said MN's/MR's upstream MRs LCoA registrations is transferred to the MAP from which the said MN/MR has derived its RCoA. Such a transfer takes place from the above said upstream MRs MAPs. Basically, the MR will inform the other MAP addresses available to it, to the MAP from which it derives its RCoA and using this information, appropriate MAP transfers takes place between MAPs via the fixed network links.

The advantage of the second approach when compared to the first is that, the transfers are taking place in the fixed network where as in the first approach the on-demand registrations are done via the wireless domain using scarce wireless bandwidth. Nevertheless, in the second approach, more changes has to be done to the MAP to implement this method, more processing burden on MAP to carry out such transfers and more memory may be required to store other MAP addresses in MAP's binding cache.

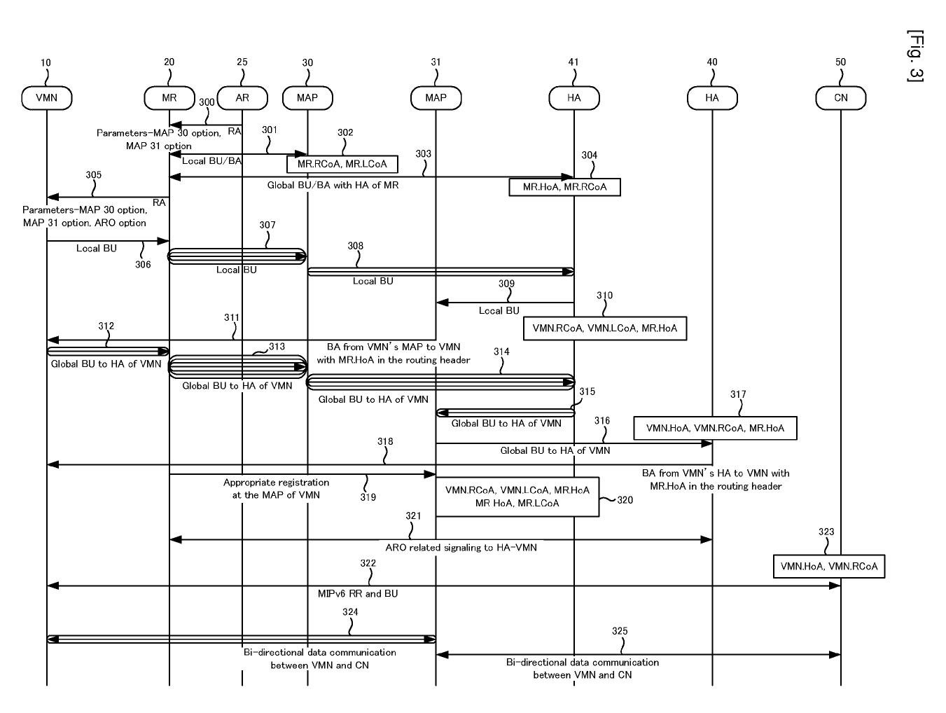

In a first preferred embodiment, the above said first approach is disclosed. FIG. 3 shows the message sequence chart when an arbitrary VMN 10 and an arbitrary CN 50 are communicating using the previously outlined first approach. VMN 10 is directly attached to MR 20 and MR 20 is directly attached to AR 25. VMN 10 and MR 20 are roaming in a local mobility management domain comprising of MAP 30 and MAP 31. The home agents of VMN 10 and MR 20 are HA 40 and HA 41 respectively. It is assumed that VMN 10 and CN 50 are having a data communication session with each other. It is further assumed that VMN 10 and MR 20 have ARO and pure HMIPv6 protocols implemented and the MAP 30 and MAP 31 are ARO enabled HMIPv6 type of MAPs. It is also assumed that HA 40, HA 41 and the CN 50 are also ARO enabled.

MR 20 roams into the sub-network for which AR 25 is the default router. After making appropriate authentication and attachment at Layer 2, MR 20 receives RA 300 containing MAP options revealing the presence of MAP 30 and MAP 31. It is considered that the preference value obtained in the MAP options is greater than “zero” and MR 20 decides to only use MAP 30 to configure its RCoA. After MR 20 configures its LCoA and RCoA, it makes local registration as shown by 301 with MAP 30. After such registration, the BCE at MAP 30 will be as shown by 302.

Following this local registration, MR 20 will next carry out global registration at its home agent HA 41 by sending the BU message 303. BCE 304 shows the BCE created at HA 41 as a result of registration 303. Next, MR 20 will send out an RA 305 containing MAP 30, MAP 31 and ARO options in its NEMO link. VMN 10 can be in a state where it decides to process the ARO option and the MAP 31 option. It is considered that VMN 10 chooses one of the MAP options only. As discussed previously, there is no major reason to process both available MAP options to communicate with CN 50.

After VMN 10 forms its LCoA and RCoA, it will make a local registration at MAP 31. This local BU is shown by message segments 306, 307, 308 and 309. A person skilled in the art would understand that the above mentioned message segments are subjected to various levels of tunneling because MR 20 does not have any registration at MAP 31. Once VMN 10 completes its local registration at MAP 31, MAP 31 will have the entries as given in BCE 310. Since VMN 10 process ARO and MAP 31 options, ARO option is attached in the local BU. MAP 31 being an ARO enabled MAP, will next send the ACK to this local registration. This ACK will have home address of MR 20 as first destination address. This ACK message is shown by 311 in FIG. 3. A detail tunneling and routing path is not shown for the message 311 and one skilled in the art can easily deduce it.

Immediately after sending the Local BU, VMN 10 may next send the Global BU to its HA 40. This is shown by message segments 312, 313, 314, 315 and 316. Once again it can be seen that this global registration message is going through many levels of encapsulations due to MR 20 not having any registration at MAP 31 and HA 40. Once VMN 10 completes its global registration at HA 40, BCE 317 is created at HA 40. Since HA 40 is ARO enabled, it will send an ACK where the first destination address of the ACK will be home address of MR 20. This ACK message is shown by 318 in FIG. 3. Nevertheless, the detail tunneling and routing associated with message 318 is not disclosed for simplicity.

When MR 20 receives ACK 311, it will realize that the message is coming from another MAP in the domain. According to our present invention, MR 20 need not make any registration at this MAP since it knows that it is not its own MAP or a CN. Even if MR 20 makes a registration, since it has derived RCoA as its care-of address it will usually make a HoA, RCoA registration at MAP 31. Instead, to allow MAP 31 to trace the LCoA of VMN 10 and LCoA of MR 20, MR 20 makes a HoA, LCoA registration at MAP 31. This registration is the first main invention and this is shown by message 319 and the registration created at MAP 31 is shown by the second row of entries in BCE 320. Again, as mentioned previously, the entire tunneling and full routing path associated with message 319 is not disclosed for simplicity. It can be readily understood that the HoA, LCoA registration associated with message 319 has to include RR process as well. It can be well appreciated by one skilled in the art that the RCoA of VMN 10 can be fully traced using BCE 320 and the ARO tracing mechanism. After ARO tracing, the LCoAs of MR 20 and VMN 10 can be obtained because adequate registration entries are available at MAP 31. After such registration 319, MR 20 will next respond to the ACK it received from HA 40 and send appropriate registration message 321 to HA 40. MR 20 will consider HA 40 as a normal CN because it does not have any special classification to HA 40 in its state table.

Having done the local and global location registration signaling, VMN 10 may wish to carry out local mobility management related RO with CN 50 and thus will perform RR and MIPv6 BU with CN 50 and disclose its RCoA as its care-of address. Such registration to CN 50 and consequently formed BCE at CN 50 is given by 322 and 323 respectively. When CN 50 wants to send data to VMN 10, it will send the packet to RCoA of VMN 10. In this case, the packet will reach the home link of MAP 31 and will be intercepted by MAP 31. MAP 31 will have all the LCoAs required to reach RCoA of VMN 10 optimally (BCE 320). Thus the above said data packet will be put in a tunnel and the tunnel destination address will be set to LCoA of MR 20. The tunnel RH2 will have LCoA of VMN 10 and RCoA of VMN 10. This will be an optimized path and such bi-directional data message is shown by message segments 324 and 325 in FIG. 3. When data packet originates from VMN 10 to CN 50, again it will be inserted in a tunnel. The tunnel source address will be LCoA of VMN 10 and the destination address will be MAP 31 address with the NEMO-Forward hop-by-hop option inserted into the tunnel. MR 20 will inspect this option and switch the source address to its LCoA and further route the packet and this tunnel will be completely removed by MAP 31. After decapsulating the above said tunnel, the inner packet will be further routed towards CN 50 using standard IPv6 routing mechanisms.

Basically the above method outlines an on-demand registration technique where the MR 20 only needs to make repetitive registration at the other MAP until VMN 10 is attached to it. The only disadvantage with this method is that when there are numerous MNs and MRs in the nested NEMO and there are many MAPs available, such other MAP registrations can increase the signaling load considerably and reduce the available bandwidth for data traffic in nested NEMO. Nevertheless, in many practical scenarios, nested NEMO is not too big and this method proves to be very useful to eliminate the routing sub-optimality issue disclosed in the prior art. Moreover, in this on-demand other MAP registration method, MNs and MRs in nested NEMO can randomly choose among any MAP in its default routing path and thus the probability of any one particular MAP getting overloaded is very slim.

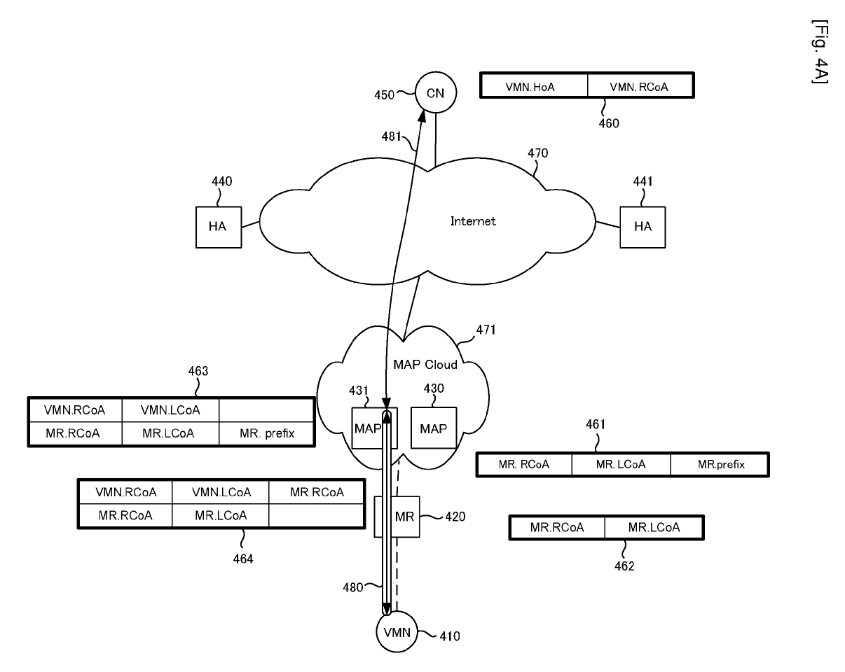

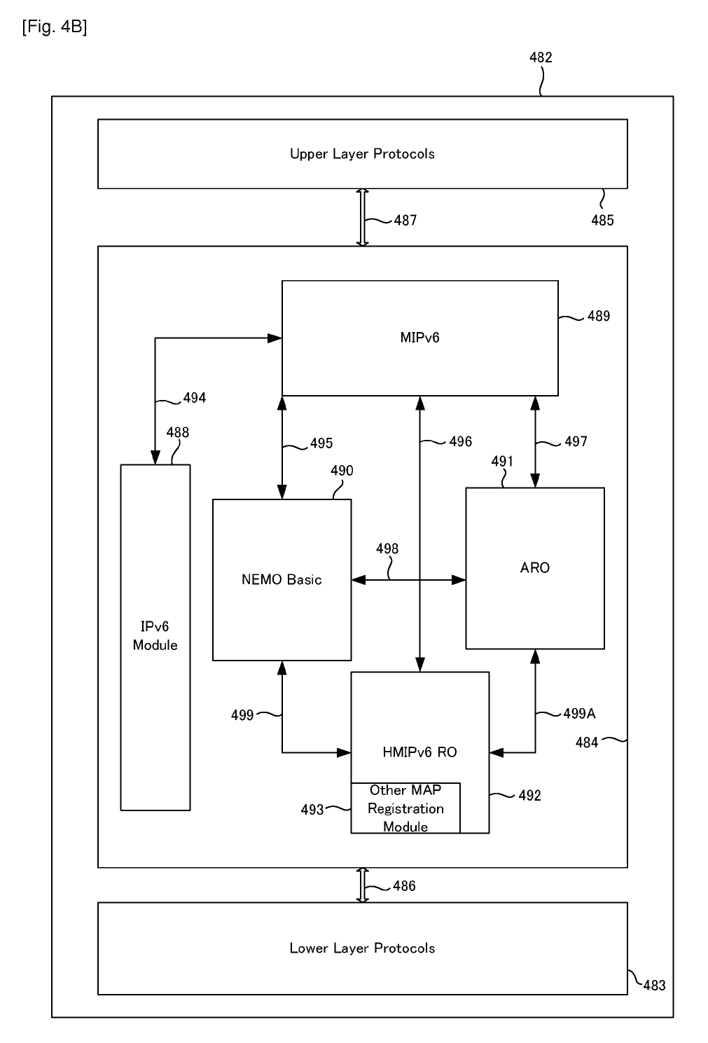

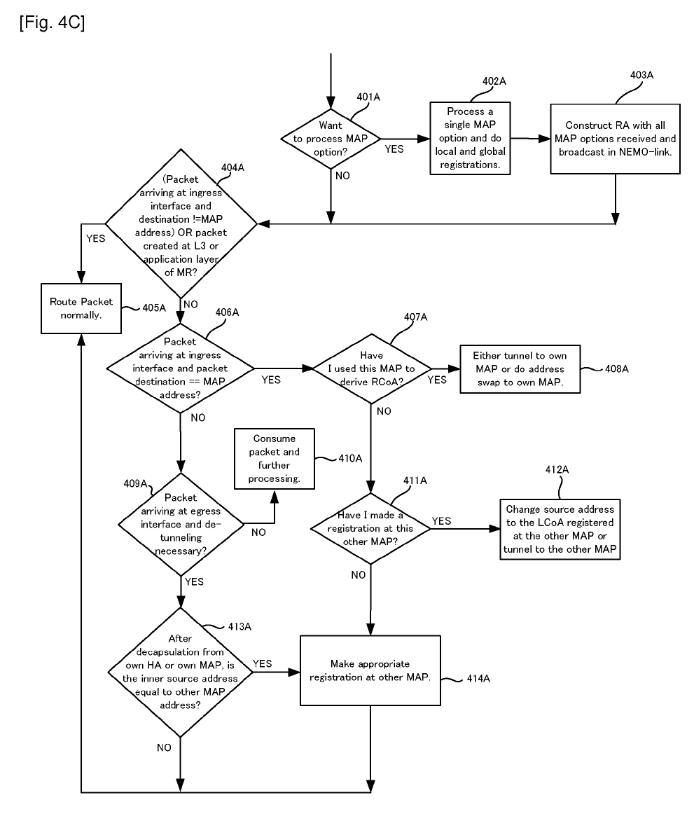

In another preferred embodiment of the present invention, for a scenario similar to that given in FIG. 3, the main invention disclosed via FIG. 3 is further explained. FIG. 4A describes this alternate scenario where the previously described main invention is operating. In FIG. 4A, it is assumed that VMN 410 and MR 420 have ARO and some HMIPv6 RO functionality. In this scenario it is further assumed that the VMN 410, MR 420, MAP 430 and MAP 431 have different HMIPv6 RO functionality to that disclosed in FIG. 3. It is assumed that all these have a prefix delegation/PSBU type of HMIPv6 RO functionality or a modified ARO enabled HMIPv6 functionality where the mobile access router's RCoA is given as the ARO parameter when doing local registration at its own MAP.

When the system nodes (VMN 410, MR 420, MAP 430 and MAP 431) have prefix delegation based/PSBU based HMIPv6 RO functionality, the binding cache created at MAP 430 and MAP 431 are given by BCE 461 and BCE 463 respectively. When the system nodes (VMN 410, MR 420, MAP 430 and MAP 431) have a modified ARO enabled HMIPv6 functionality where the mobile access router's RCoA is given as the ARO parameter to its MAP, binding cache created at MAP 430 and MAP 431 are given by BCE 462 and BCE 464 respectively.

Let us first consider the sub-scenario where VMN 410, MR 420, MAP 430 and MAP 431 have prefix delegation based/PSBU based HMIPv6 RO functionality. VMN 410 is directly connected to MR 420. MR 420 uses MAP 430 to configure its RCoA and VMN 410 uses MAP 431 to configure its RCoA. The home agents of VMN 410 and MR 420 are HA 440 and HA 441 respectively. It is also assumed that VMN 410 is having a data communication session with CN 450. The above said MAPs are rigidly placed in the MAP domain 471, which is in turn connected to the Internet 470.

MR 420 may possibly perform a prefix-oriented local registration at its MAP 430. The created entry after such registration is shown by BCE 461. The RCoA of MR 420 is derived from MAP 430 and the prefix registered at MAP 430 may well be a prefix delegated from MAP 430 or HA 441. Following which, VMN 410 may perform a local registration at its own MAP, which is MAP 431. The entries created at MAP 431 after such VMN 410 registration is shown by the first row of entries in BCE 463. It is assumed that the LCoA of VMN 410 in BCE 463 is derived from the prefix parameter given in BCE 461. When MAP 431 sends its ACK to LCoA of VMN 410, this ACK will need to be tunneled from home agent HA 441 and/or tunneled from MAP 430. In this case, after de-tunneling this ACK originally sent from MAP 431, MR 420 can realize that it has no attachment with MAP 431 (as the ACK packet was tunneled from home agent of MR 420 and or MAP 430) and furthermore a down stream MN/MR is attached to this other MAP. In such an event, using the first main invention as disclosed via FIG. 3, MR 420 would check this address obtained (MAP 431) after detunneling is the other MAP address and then make another registration at MAP 431. After this registration, the entries created will be the second row of entries in BCE 463. The above said second row of entries is identical to the BCE 461 entries. It is important to understand that MR 420 does not derive another RCoA at MAP 431 to make its registration at MAP 431. If another RCoA is derived then it complicates matters as it will increase the ND-Proxy signaling at MAP 431 and also use more memory resources there. Furthermore, the LCoA of VMN 410 has to be derived from prefix delegated to MR 420 from this other MAP and this increases the RA signaling load. From the above discussion, it can be well appreciated that, MR 420 making duplicate registration at MAP 431 using the same location registration values which it has used at its own MAP 430 (i.e. BCE 461 entries) is a better solution.

From previous discussion, it is evident that the RCoA of MR 420 registered at MAP 431 was derived from MAP 430. Furthermore, the prefix entry registered at BCE 463 can be a prefix that was delegated to MR 420 by MAP 430 or a prefix given to MR 420 from HA 441. Thus the same registration that was made by MR 420 at MAP 430 is merely repeated at MAP 431. In such a duplicate registration method, MR 420 can very readily pass the local registration values it made at its MAP 430 by using a common trusted key. MAP 430 and MAP 431 can pre-establish a common trusted key and this key could possibly be passed to MR 420 when establishing a successful local registration with its MAP 430. Such a key can be used to create appropriate authentication headers (AH) or certificates or encapsulating security payload (ESP) when MR 420 makes its other MAP duplicate registration at MAP 431. It can be well understood by one skilled in the art that MAP 431 need not do any address validity for the above said registration done by MR 420. This is because it trusts that MAP 430 has already done it.

It is further considered that since all the LCoAs required to optimally reach RCoA of VMN 410 is made available at MAP 431 using a method associated with the main invention disclosed in this current embodiment, VMN 410 could possibly give its RCoA to CN 450 via RR and MIPv6 registration. When such registration is made at CN 450, the BCE will look like that given by BCE 460. When CN 450 sends data packet to VMN 410, the destination address will be set to RCoA of VMN 410 and the packet will be intercepted at MAP 431. MAP 431 will look for a route to this RCoA of VMN 410. MAP 431 will use the prefix matching technique where the LCoA prefix is matched to the prefix entries to find all the LCoAs required reaching a RCoA optimally. Using such a method, MAP 431 can readily trace LCoA of MR 420 and LCoA of VMN 410. Thus the above said data packet will be encapsulated in a tunnel and sent to VMN 410 via a most optimized path. Such a route-optimized path is shown by message segments 480 and 481 in the FIG. 4A. In summary, using appropriate on-demand duplicate registration at the other MAP, local mobility management based RO is achieved between VMN 410 and CN 450. Such local mobility management based RO is very effective in saving the battery power of VMN 410 and also reducing the average location management signaling injected into the network per single change of network attachment by VMN 410.

We next consider the sub-scenario where VMN 410, MR 420, MAP 430 and MAP 431 have a modified ARO enabled HMIPv6 functionality where the mobile access router's RCoA is given as the ARO parameter when registering at its MAP. In this case, MR 420 will again configure RCoA from MAP 430 and make a local registration at MAP 430. Such registered entries are shown by BCE 462. It is further assumed that VMN 410 will have the RCoA of MR 420 available to it via the ARO option it receives from RA. This RCoA of MR 420 is derived from MAP 430. In this case, VMN 410 can preferably use this ARO parameter when doing registration at its own MAP 431. Such created entry is given by first row of entries in BCE 464. MAP 431 will send an ACK with first destination address set to RCoA of MR 420. In this case, MR 420 will make the RCoA, LCoA registration at this other MAP 431. This said MR 420 registration at MAP 431 would create entries as shown by the second row of entries in BCE 464. The second row of entries in BCE 464 is identical to BCE 462 entries. In normal operation of ARO, MR 420 will only make such a recursive registration when it receives an ACK destined to its global home address. Nevertheless, using a new functionality in the MR 420, it is assumed that even when it receives an ACK sent to its RCoA it will send its duplicate registration. Again, anyone skilled in the art can readily see that the BCE 464 can be used to find all the LCoAs required reaching RCoA of VMN 410 in the most optimal manner. Again as discussed previously it should be appreciated that MR 420 is already attached to a MAP 431 and hence need not make another registration at another MAP. Nevertheless, to enable route optimization to a down stream MN/MR it makes such duplicate registration at the MAP of VMN 410.

In another preferred embodiment of the present invention, the functional architecture of MR, which implements the previously described duplicate on-demand registration method, is disclosed. This said functional architecture is given by FIG. 4B. The protocol stack 482 comprises of all software and hardware required for participating in communications with other peer nodes. It is further assumed that the MR will sometimes operate as a MN when it wants to communicate with some CNs. The lower layer protocol module 483 comprises of all the software and hardware required to implement physical layer and data link layer functionalities. The module 484 comprises of all the routing related software and hardware functionality. The module 485 comprises of all the software and hardware required to implement the upper layer protocol functionality. The said upper layer protocols 485 can possibly be transport, socket and application layer protocols. In FIG. 4B, signal path 486 describes the interface between modules 483 and 484, and signal path 487 describes the interface between modules 484 and 485. These interfaces comprises of hardware and software required to implement packet transfer between the modules which form as the end points of the said interface.

The routing module 484 can preferably be implemented as a plurality of sub modules. The said sub-modules are IPv6 module 488, MIPv6 module 489, NEMO Basic module 490, ARO module 491 and HMIPv6 RO module 492. It is further assumed that only codes purely related to a sub-module is implemented in that sub-module. Some codes that are implemented in some other sub modules can be re-used by the sub-module via appropriate interfacing between sub-modules. Thus it is considered that these sub-modules are further interconnected. Nevertheless, it can be well understood by one skilled in the art that there are more than one way of implementing the said routing layer functionality without deviating from the scope of the invention.

IPv6 sub-module 488 is interconnected with MIPv6 sub-module 489 via an interface 494. MIPv6 sub-module 489 is interconnected with sub-modules NEMO Basic 490, ARO sub-module 491 and HMIPv6 RO module 492 via interfaces 495, 497 and 496 respectively. NEMO Basic sub-module 490 is interconnected with sub-modules 492 and 491 via interfaces 499 and 498 respectively. ARO sub-module 491 is interacting with HMIPv6 RO module via interface 499A. In this architecture it is assumed that the MR can be in a state where all sub-modules are triggered at the same time or only a subset of sub-modules being triggered. When the MR is roaming in a MAP domain, it is assumed that all MAP related functionality is handled by HMIPv6 RO sub-module 492. The HMIPv6 RO sub-module 492 comprises of protocols required to do MAP registration. This MAP registration is done using some RO parameter as described in the previous embodiments. The said sub-module 492 further comprises of a smaller sub-module 493 embedded in it. This module 493 is specifically responsible for performing a duplicate registration at other MAP (not MR's own MAP).

The IPv6 routing module 488 is responsible for generating and processing RA, performing link local routing, sending and receiving Internet Control Message Protocol (ICMPv6) messages, IPv6 header formation and IPv6 header processing, address configuration, neighbor discovery and so forth. MIPv6 module 489 is responsible for all software and hardware required to implement MIPv6 functionality. Although this is a mobile router, MIPv6 functionality is used for two purposes. MIPv6 functionality can be used when the MR functions as a MN or it can be used to derive other advanced functionality. Basically, MIPv6 can be used as a base class and other derived classes such as NEMO basic, ARO, HMIPv6 RO can be derived from it. When packet arrives at the IPv6 module via interface 486, after being processed at sub-module 488 it will be sent to MIPv6 module if there are some unknown parameters (mobility headers) that cannot be processed by IPv6 module 488. Otherwise, the IPv6 module will pass the packet to upper layer protocols after some processing via interface 487 or it will fully process and consume the packet. When packet arrives to IPv6 module via interface 487, these packets will be purely processed by module 488 only if the MR is at home link. Otherwise, the packet will be sent to MIPv6 module 489 for further processing. If the packets such as control packets are created at the routing module 484, then IPv6 will possibly construct it depending on the nature of the packets. For example, ICMPv6 packets will be constructed by IPv6 module 488.

All packets that arrive via interface 494 will be passed to previously mentioned sub-modules for further processing based on the parameters (for example destination address of the packet) that are found in the packet and the options being processed by the MR. The said options can be MAP options, ARO options and prefix options described in previous embodiments.

In yet another preferred embodiment of the present invention, to further understand the operation of the MR when processing packet at the routing layer 484, next, the flowchart of MR is given. This said flowchart given in FIG. 4C mainly shows the packet processing at module 484 in FIG. 4B. When a RA is received, the step 401A is triggered. Step 401A involves the decision of whether to process the MAP option or not. If it is decided to process MAP option, then step 402A is executed. This step 402A involves methods associated with processing of a single MAP option out of a plurality of MAP options, configuring LCoA, RCoA and making local registration at the chosen MAP and also doing global registration at one or more of MR's home agents and some CNs of MR (if there are any). After executing step 402A, the control will go to step 403A. In this step 403A, all the MAP options received will be embedded in a RA and sent out. After this step 403A, the control will follow to step 404A. This step 404A will check whether there are any packets at the ingress interface to other addresses other than MAP addresses or does the MR have some packets that were created in MR. If 404A evaluates to “yes”, then, the step 405A will be executed. Basically, if the packet is to some other address (not MAP addresses), then the MR may tunnel the packet via it's HA. The step 405A shows standard routing mechanisms that will be followed; depending on the standard stacks that are triggered at layer three of MR. One skilled in the art can readily interpret this functionality in step 405A based on the mobility routing mechanisms implemented at MR.

If step 401A evaluates to “false” or “no”, then again step 404A is carried out and in the event that 404A evaluates to “yes” the previously mentioned step 405A will be carried out.

If step 405A evaluates to “no”, then step 406A is carried out. In this step 406A, it is checked whether the packet has arrived via ingress interface and whether the destination address is set to some MAP address that is known to the MR (received via RA). If, step 406A evaluates to “yes”, then step 407A is carried out. This step 407A is to check whether the destination address of packet is equal to the MAP address from which MR derived its RCoA. If it is so, then the MR knows it has registrations at that MAP address and it could possibly execute step 408A. The step 408A involves a method where the packet is either tunneled to MR's own MAP or the source address is switched to LCoA of MR and the packet is routed further. After this step 408A the control will possibly go back to step 401A.

If step 407A evaluates to “no”, that means the destination address associated with the packet at ingress interface is equal to some other MAP address. Thus, the step 411A is next carried out to check whether the MR has a registration at this other MAP. If 411A test evaluates to “no” then step 414A is carried out. This means that if there is no registration at the other MAP, the MR makes appropriate registration at the other MAP. As explained in previous embodiments, the type of registration parameters at other MAP depends on the HMIPv6 RO mechanism at the MAP in the domain. After making this other MAP registration, the control will go to step 405A, where the packet will be routed normally using standard operation. Or the packet can be buffered for some time and then be sent via an optimized route created by registering at the other MAP. If, when step 411A is executed, it is found that the registration at the other MAP has already been done, then step 412A will be carried out. In such a case, the packet will be tunneled to the other MAP or the source address will be changed to the LCoA and routed further to the other MAP.

If step 406A evaluates to “no”, then control will come to step 409A. This step 409A constitutes a method where it is checked whether the packet arrived via egress interface and the packet is destined to the MR. If step 409A evaluates to “yes”, then step 410A is carried out. When executing step 410A the packet will be consumed by the MR. This packet will be fully processed at layer three of MR or it may be further sent to the upper layers of MR. If when evaluating step 409A, the step evaluates to “yes”, that means first the packet will be decapsulated and then step 413A will be performed. In this step 413A, it is checked whether after decapsulation, the inner packet source address is equal to other MAP address. In this case, the MR knows that it does not have registration at other MAP, and hence control will be passed to step 414A. Again appropriate registration will be made at other MAP and the packet will be passed to step 405A where standard mechanisms will be used to route packet further. After performing step 405A, the control will go back to step 401A. If step 413A evaluates to “no”, then the packet will again be sent to step 405A for further routing.

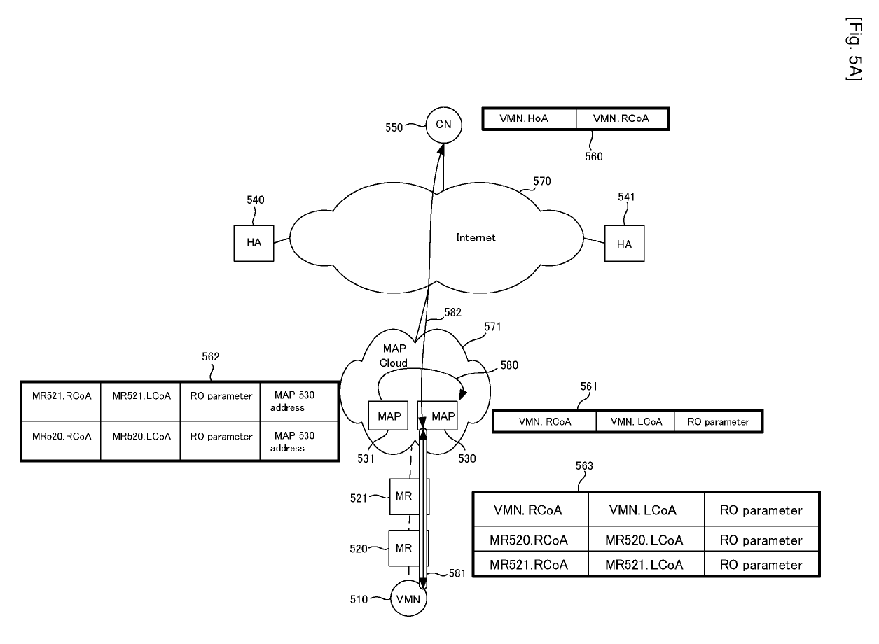

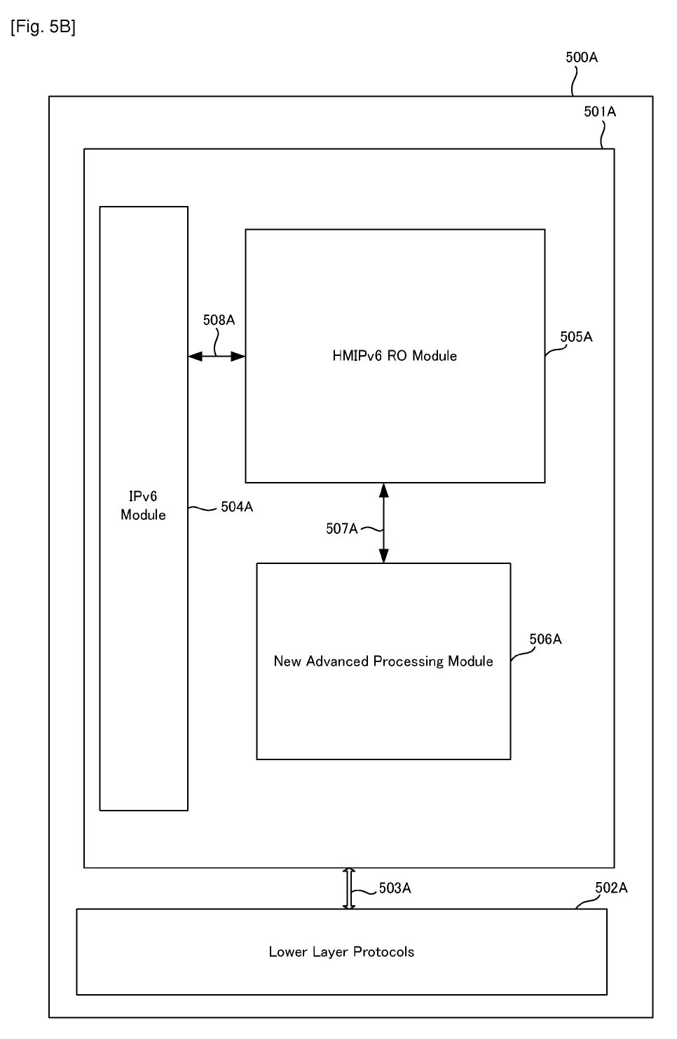

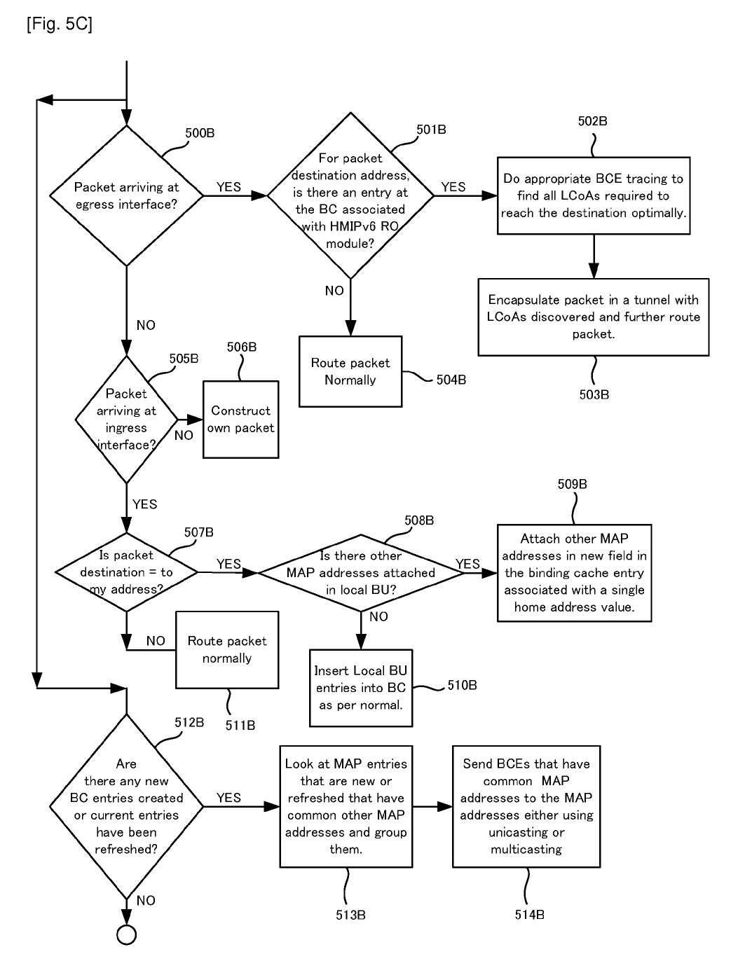

In yet another preferred embodiment of the present invention the second approach of the main invention or rather the second main invention is disclosed. This second main invention is such that, again, local mobility management based RO is provided for VMN to CN data traffic in a multi-MAP environment without trading off the load-balancing feature. However, LCoA registrations that are required for reaching the RCoA of the said VMN via the most optimized path is transferred from one or more MAPs via the fixed network to the MAP from which the above said RCoA was derived. This way, the signaling burden on the wireless domain is less when compared to the first approach given in a previous embodiment. This second invention will be more clearly understood, once the associated FIGS. 5A to 5C, which reveals this second approach, is understood.

In FIG. 5A, VMN 510 is directly attached to MR 520. MR 520 is directly attached to MR 521 and the nested NEMO rooted at MR 521 is attached to the local mobility management domain 571. It is further assumed that the MAP domain 571 is connected to the Internet 570. It is also assumed that VMN 510 is having a data communication session with CN 550, which is in turn connected to the Internet 570. In this scenario it is assumed that VMN 510, MR 520 and MR 521 receive both MAP options. That is, MAP option originated from MAP 530 and MAP option originated from MAP 531.

The core point about the second method described via FIG. 5A is that MNs and MRs in a nested NEMO tree path can choose any one MAP option available to configure its RCoA and yet all the LCoAs required to reach the above said MN's or MR's RCoA is made available at the MAP from which the said RCoA is derived via MAP to MAP transfer. Thus in this method, it is assumed that when the MR is sending a local registration to a MAP of its choice, it will send the other MAP addresses it has seen in its RA. Basically, the MRs are giving a “hint” to its own MAP about the other MAPs at which the MNs/MRs in its nested NEMO tree path have made their local registration. The MAP will use this “hint” (given via other MAP addresses) to pass its own location registration entries, to other MAPs so that the other MAPs could trace all the required LCoAs required to reach a RCoA that was uniquely derived from the said other MAP.

When such a method is in operation, in FIG. 5A, it is assumed that MR 521 processes the MAP 531 option to configure its RCoA. MR 521 will then make a local registration at MAP 531 and the created entries are given by the first row in BCE 562. When making the local registration, MR 521 will preferably attach the other MAP address, which is MAP 530 address as an option in its BU mobility header. The RO parameter given in BCE 562 reflects the HMIPv6 related RO mechanism implemented in the system. These RO parameters given in the figure could be upstream mobile access router's HoA, upstream mobile access router's RCoA or a prefix delegated by its own MAP or by its own HA. It can be understood by one skilled in the art that these RO parameters are essential to trace all the LCoAs required to reach a RCoA optimally. Furthermore, in the previous embodiment an elaborate explanation as to how to use these RO parameters to find the relevant LCoAs and the tracing mechanism has been clearly explained. To keep the explanation simple in this embodiment, no further detail explanation of this will be given.

Next, after appropriate local registration at the MAP of its choice, MR 521 would send its RA and MR 520 is assumed to process MAP 531 option to make its local registration. When MR 520 completes this local registration, the created entries will be given by the second row of entries at BCE 562. Again, MR 520 will give MAP 530 address when it performs the BU. This is a “hint” to MAP 531 that another MN or MR in the same nested NEMO tree path associated with MR 521 and MR 520 is possibly attached to this MAP 530 and would possibly need the MR 521 and MR 520 entries to trace the RCoA that is registered at MAP 530. When MR 520 sends it RA, it is assumed that VMN 510 uses the MAP 530 address to make its local registration. Since VMN 510 is a mobile node and not a router, it need not send other MAP addresses in its BU. This can be easily understood by one skilled in the art, because, no other MAP need this LCoA of VMN 510 (LCoA of VMN 510 is a leaf address) to reach a RCoA. The local registration entry created after this said registration at MAP 530 is shown by BCE 561.

MAP 531, whenever it has new entries or when old entries are refreshed, will trigger a mechanism associated with this second main invention. This said mechanism is such that, MAP 531 will search for entries that have the same other MAP addresses. If these entries are new or just refreshed, then, it will pass all these entries to the other MAP addresses. Basically, for this scenario, MAP 531 will pass all the registered entries given in BCE 562(except the other MAP addresses) to MAP 530. After the said transfer, BCE 563 gives the new entries created at MAP 530. It is assumed that the said MAP-to-MAP transfer is done securely by means of a security key that is mutually accepted among the MAPs in the MAP domain 571. It can be readily understood by one skilled in the art that if there are more than one other MAP addresses in the fourth column of BCE 562, then the two row of entries have to be passed to all the other MAP addresses available. Since BCE 563 has all the required entries to reach RCoA of VMN 510 optimally, it can be well understood that the bi-directional data communication between VMN 510 and CN 550 will travel via the most optimized path as shown by the path segment 581 and 582 in the figure.

It is important to appreciate the difference between the method disclosed in this current embodiment and the duplicate on-demand registration done via wireless domain. Both are similar in their effect in the sense that duplicate entries are made at the required MAPs but only based on demand from other nodes in the nested NEMO. Another good feature with both the approaches is that, load balancing is not traded off and any MN/MR in the nested NEMO can choose whatever MAP out on n number of MAPs available with a probability of 1/n. Thus, usage of all the above said n MAPs will be similar and MAP failure due to overloading can be avoided.

In another preferred embodiment of the present invention, to further understand the operation of the MAP in the embodiment associated with FIG. 5A, the functional architecture of MAP is explained. This said functional architecture is given by FIG. 5B. In FIG. 5B, 500A shows the MAP protocol stack including all the software and hardware required to implement the protocol functionalities. The lower layer protocol module 502A consists of all the physical and data link layer protocols. The module 501A shows the routing layer protocol functionality. Since MAP is mostly a fixed router, it does not have higher protocol layers. The routing layer 501A further comprises of IPv6 module 504A, HMIPv6 RO module 505A and the new advanced processing module 506A. IPv6 module implements all functionalities associated with standard IPv6 mechanisms. HMIPv6 RO module implements a particular HMIPv6 RO mechanism that was outlined previously. It is further assumed that inside this HMIPv6 RO module, there is also binding cache associated with the module. The above said new advanced processing module 506A comprises of functionality where it will monitor periodically the BC entries in 505A module and make relevant transfer of BC entries to the single or a plurality of MAPs identified. The IPv6 module 504A has interface to the HMIPv6 RO module 505A via 508A. The HMIPv6 RO module 505A has interface to the new advanced processing module 506A via interface 507A. The lower layer protocol module 502A has an interface with the routing module 501A via interface 503A.

When packets reach the routing module 501A via interface 503A, it will either be fully processed by IPv6 module or passed to the HMIPv6 RO module. Basically, if IPv6 module can fully process such packet it will be processed there. Otherwise, the HMIPv6 RO module will process the packet.

In a further preferred embodiment of the present invention, the MAP packet processing methods at module 501A in FIG. 5B is explained. The MAP processing at the said layer is shown in FIG. 5C. At MAP, initially the step 500B is carried out. The step 500B first checks whether there any packets arriving at egress interface. If step 500B evaluates to “yes”, then control goes to step 501B. Here it is checked whether the destination address of packet has an entry in the BC of the HMIPv6 RO module described in the previous embodiment. If step 501B evaluates to “yes”, then step 502B is carried out. In this step 502B the tracing of BC to find all the LCoAs required to reach the destination address is performed. After finding the required LCoAs, step 503B is performed. In this step 503B, using the identified LCoAs in step 502B the packet is encapsulated in a tunnel and further routed. After this step 502B, the control may possibly go to 500B or 512B (depending on the time of event that has to be processed first). If when processing step 501B, this step 501B evaluates to “no”, then the packet will be routed normally according to standard mechanisms. That is the MAP does not have any BC entire for the destination address and perhaps it needs to be routed using IPv6 routing mechanisms.

If after carrying out step 500B it is found that this step evaluates to “no”, then the step 505B is carried out. At step 505B, it is checked whether the packet arrived via an ingress interface. If step 505B evaluates to “no”, then the packet is originated at MAP and thus the step 506B will be carried out. At step 506B, the packet will be constructed and routed as in standard mechanism. Nevertheless, if step 505B evaluates to “yes”, then the control will move to step 507B. At step 507B, it is checked whether the packet arriving at ingress interface is destined to the MAP. If 507B evaluates to “yes”, then step 508B is executed. At step 508B it is checked whether this packet is a Local BU and whether there are any other MAP addresses attached. If step 508B evaluates to “yes”, then step 509B is carried out. At step 509B, the other MAP addresses are placed at memory locations associated with a RCoA value. If step 508B evaluates to “no”, then step 510B is performed. At step 510B, the local BU entries are placed as per normal operations.

If the current event in the event scheduler is the event associated with step 512B, then that step 512B will be triggered. The step 512B checks whether there are any new BC entries created or whether any entries have been renewed or refreshed. If 512B evaluates to “yes”, then step 513B is executed. Step 513B has functionality where the BC entries with common other MAP addresses are grouped together. After processing step 513B the control is passed to step 514B. Here, the other MAPs identified in step 513B are informed of the changed or new BC entries. After completing step 514B, the control is passed to the main loop. It can be 500B or 512B depending on the event that is first in the event scheduler.

In yet another preferred embodiment of the present invention, if MR 521 in FIG. 5A sees many MAP options in a received RA, it may preferably choose only certain number of MAPs out of all the available MAP options. It may preferably choose MAP options whose preference level is greater than some level of threshold. It is important to understand that high preference level is usually set when the MAP is not overloaded. By MR 521 doing this MAP options filtering or selection procedure, the transfer signaling from MAP to other MAPs can be reduced and thus congestion in the MAP domain can be reduced. Basically, if a MR registers fewer other MAP addresses, then the MAP which takes this registration needs to transfer the entries to fewer MAPs in the MAP domain and thus reduce the MAP domain network traffic. Moreover, better load balancing may be achieved using this filtering method by not overloading MAPs that are already quite heavily overloaded. This decision of MR 521 filtering out certain MAP options may possibly be done by another MAP in the MAP cloud.

In one preferred embodiment of the present invention, when MR 521 and MR 520 make registration at their selected MAP they need not send other MAP addresses. MAPs can do a self-check on their BCE to see whether all the required LCoAs are present to reach a RCoA registered there. For example, if the RO parameter in FIG. 5A is upstream mobile access router's RCoA, then, the RO parameter entry at BCE 561 will have RCoA of MR 520. MAP 530 can possibly know by doing a self-check that further entries to trace RCoA of VMN 510 are not present at BCE 561 because no match for RCoA of MR 520 can be found at BCE 561. In this case, MAP 530 can intelligently know by inspecting RCoA of MR 520 that this address was derived at another MAP. MAP 530 may preferably have information on all MAP addresses in the domain and hence can find a suitable MAP address prefix that matches with the RCoA of MR 520 address prefix. Once MAP 531 address is decided upon by MAP 530 using the above-mentioned matching technique, MAP 530 could possibly send a query to MAP 531 with RCoA of MR 520 attached. Then the MAP 531 needs to understand this query and use the RCoA of MR 520 to trace the required entries that has to be transferred to MAP 530. Thus, MAP 531 will first locate the RCoA of MR 520 at its BCE 562. It then conducts tracing and will find that both row of entries in BCE 562 need to be transferred and will transfer them to MAP 530.

The difference between this and the previous technique where the other MAP address was sent in the option is that in this technique, “query” and “response” are required to get the BCE entries and this is more of a reactive type of transfer; whereas the former technique is more of a proactive type of transfer. In another way, MAP 530 need not have other MAP information but can send an anycast message constructed using the prefix of RCoA of MR 520 to trace the relevant MAP. Of course, that MAP 531 should be assigned this anycast address value. For one skilled in the art, not only these there may be numerous ways to trace the other MAP in order to send the query message mentioned in this embodiment. It is also important to appreciate if the system has a prefix delegation based/PSBU based HMIPv6 RO mechanism, the MAP 530 by merely inspecting the LCoA of VMN 510 entry at BCE 561 can find the MAP at which the other entries are available. This can be easily understood by one skilled in the art.

In yet another preferred embodiment of the present invention, if a MR knows by some means—that the MAP options processed by downstream MRs or MNs (for example, MR 520 and VMN 510 are downstream to MR 521), then the MR will only send downstream MRs and MNs the MAP addresses in the registration it makes to its own MAP. This is because a particular MR's location registration value is required only at the MAPs of downstream MRs and MNs. The upstream MRs MAPs do not need downstream MRs' registrations. In this way, not all MAP addresses need to be sent as disclosed in a previous embodiment that explained FIG. 5A. Thus, the method disclosed in the current embodiment is an optimization to the second main invention that was revealed by FIG. 5A.

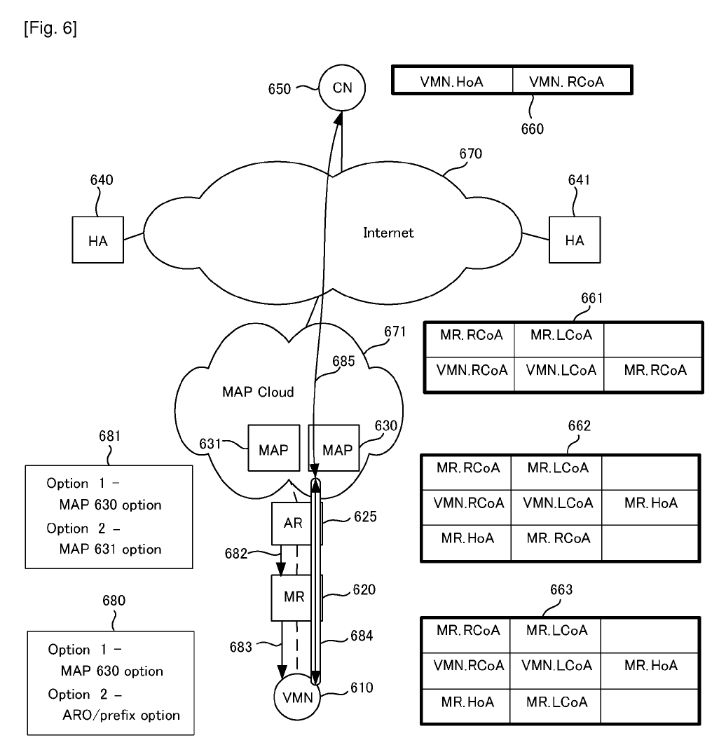

In yet another preferred embodiment of the present invention, another variation of the main invention is disclosed. This variation is explained via FIG. 6. This variation is such that, on-demand duplicate registration is not done in this variation. Nevertheless, for MAPs that have the same preference level in the domain, this method may overload certain MAPs. More will be explained when the FIG. 6 is analyzed in detail.

In FIG. 6, VMN 610 is directly attached to MR 620 and MR 620 is directly attached to AR 625. AR 625 is attached to the MAP cloud 671. It is further assumed that there are two MAPs placed in the cloud 671 which are MAP 630 and MAP 631. It is also assumed that AR 625 receives both the MAP options in the RA message 681 it receives. AR 625 will process the received RA and will send out a new RA 682, which will also be of the same form as shown by packet 681. It is also considered that VMN 610 is having a data communication session with CN 650. When the invention disclosed in the current embodiment is in operation, it is considered that the BCE at CN 650 is given by 660.

It is further assumed that if the system (VMN 610, MR 620, MAP 630 and MAP 631) has ARO enabled HMIPv6 functionality with ARO parameter being mobile access router's RCoA (sub-scenario 1), then BCE 661 will be created at the MAP 630 when the invention disclosed in the current embodiment is operating. If the system (VMN 610, MR 620, MAP 630 and MAP 631) has ARO enabled HMIPv6 functionality with ARO parameter being mobile access router's HoA and some MAP intelligence (sub-scenario 2), then BCE 662 will be created at the MAP 630 when the invention disclosed in the current embodiment is operating. If the system (VMN 610, MR 620, MAP 630 and MAP 631) has ARO enabled HMIPv6 functionality with ARO parameter being mobile access router's HoA (sub-scenario 3), then BCE 663 will be created at the MAP 630 when the invention disclosed in the current embodiment is operating.

When analyzing the problem in the prior art, it was clearly understood that in a multi-MAP scenario where multiple MAP options are available, MNs and MRs in nested NEMO tree path can end up choosing different MAPs to configure RCoAs and thus route sub-optimality occurred. To resolve this problem, it is assumed that when MR 620 receives RA 682 and realizes that the MAPs are not too overloaded or have similar preference values, MR 620 decides to register at a single MAP (in this case MAP 630) and hence only send the MAP 630 option in the RA it creates. This is the core point of the invention disclosed in this current embodiment. Thus, MR 620 does a local registration at MAP 630, which is shown by the first row of entries in BCE 661, BCE 662 and BCE 663. After that, MR 620 will send its RA 683 and in this RA 683 it will only send the MAP 630 option. This can be seen by packet 680. This packet 680 may also have ARO parameter and/or some prefix parameter.

In the event of receiving such a RA 683, VMN 610 in sub-scenario 1 will first process the MAP 630 option and make a local registration at BCE 661 and the created entries are shown by the second row of entries at BCE 661. From BCE 661 it can be seen that RCoA of VMN 610 can be readily traced using the ARO mechanism and thus the data packet coming from CN 650 will be encapsulated in a single tunnel at MAP 630. The tunnel first destination address will be LCoA of MR 620 and the final address will be LCoA of VMN 610.

In the event of receiving such a RA 683, VMN 610 in sub-scenario 2 will first process the MAP 630 option and make a local registration at BCE 662 and the created entries are shown by the second row of entries at BCE 662. After the second row of entry is created, since the MAP 630 does not have registration to HoA of MR 620, it will send an ACK to VMN 610 but the first destination address will be set to HoA of MR 620. When MR 620 receives this, it will further send an ARO registration using RCoA because its care-of address is set to RCoA. This said ARO recursive entry is shown by the third row of entry at BCE 662. MAP 630 can possibly use some intelligent tracing to find all the LCoAs required reaching RCoA of VMN 610 optimally.

In the event of receiving such a RA 683, VMN 610 in sub-scenario 3 will first process the MAP 630 option and make a local registration at BCE 663 and the created entries due to this said registration are shown by the second row of entries at BCE 663. After the second row of entry is created, since the MAP 630 does not have registration to HoA of MR 620, it will send an ACK to VMN 610 but the first destination address will be set to HoA of MR 620. When MR 620 receives this, it will further send an ARO registration where the addresses registered will be HoA and LCoA of VMN 610. Thus, this said ARO recursive entry is shown by the third row of entry at BCE 663. MAP 630 can possibly use its normal ARO tracing operation to find all the LCoAs required reaching RCoA of VMN 610 optimally.

It can be well understood by one skilled in the art that, by making all the MNs and MRs in the nested NEMO tree path attach at a single MAP, all LCoAs required to optimally reach a RCoA associated with a MN or MR in the said nested NEMO tree path can be traced (No split cache problem). Thus, data packet originated at CN 650 will traverse via the most optimized route given by message segments 685 and 684 in FIG. 6.

The main problem with the method disclosed in this current embodiment when compared to the methods disclosed via FIGS. 3, 4A to 4C and 5A to 5C is that, all the MNs and MRs in the nested NEMO (assuming a nested NEMO with a single root MR) choose a single MAP and since the distribution of nested NEMO nodes (number of nested NEMO nodes) may not be uniform over the NEMOs roaming in the MAP domain, there can be an instance that some MAPs in the MAP cloud 671 being over used and may possibly be subjected to MAP failure. Nevertheless, when the MAPs are very lightly loaded (possibly known to MR 620 via preference values), this method disclosed in the current embodiment will be useful.

In the event that nested NEMO is heavily congested, MR could possibly switch mode from the method disclosed in FIG. 3 or FIGS. 4A to 4C to the method disclosed in FIG. 6. In this case, it is assumed two mechanisms are implemented in the MR. When nested NEMO is congested, on demand duplicate registration via the wireless domain is not every efficient and the method disclosed via FIG. 6 may prove useful.

In yet another preferred embodiment of the present invention, when MR 620 in FIG. 6 realizes that it is moving towards another MAP (possibly in the same MAP domain), it can make a hint to its current MAP which is MAP 630. In that case, MAP 630 will pass all the RCoA values associated with nested NEMO nodes rooted at MR 620 and will request the new MAP to perform duplicate address detection (DAD) for the above mentioned RCoA values. The new MAP should obviously change the above said RCoA prefix to its own address prefix before performing DAD. If there is no address clash at the new MAP link, then, this can possibly be notified to MAP 630. All the BCEs associated with nested NEMO rooted at MR 620 can be transferred from MAP 630 to new MAP and the nested NEMO nodes rooted at MR 620 need not do further local registrations at the new MAP. They only need to know the new MAP address prefix and only future LCoA changes need to be registered at the new MAP. This kind of transfer can be done when MAP 630 is overloaded as well. This method is favorable because, when the MAP changes for a nested NEMO, a lot of new local registrations have to be made even when the LCoAs of the MNs and MRs in nested NEMO does not change. This method prevents such local registration storm. In this method, local registrations are done by the previous MAP doing the transfer to the new MAP and the MAP change is notified to the nested NEMO nodes.

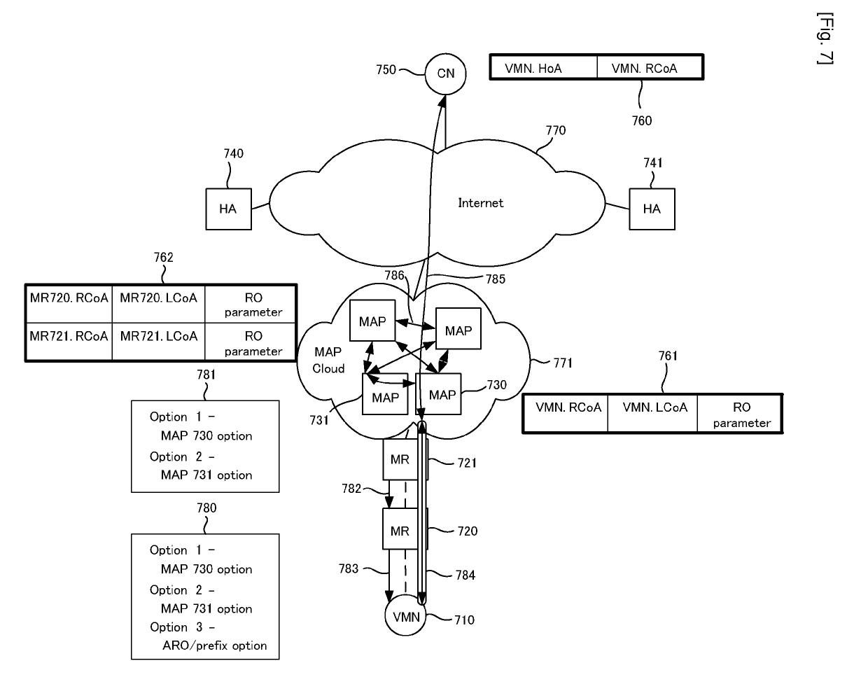

In yet another preferred embodiment of the present invention another variation of the main invention is disclosed and this said variation is further explained via FIG. 7. In the main invention disclosed previously and explained via FIG. 3 and FIGS. 4A to 4C, it was evident that on-demand duplicate registration increases signaling load considerably in highly populated nested NEMO. Even in network support solution disclosed via FIGS. 5A to 5C, it was found that MR still needs to attach other MAP addresses in its local BU to its chosen MAP. The said network support solution also occupies some significant amount of wireless bandwidth. In this embodiment, a full network based solution to the route sub-optimality problem outlined in the prior art analysis is disclosed.

In FIG. 7, VMN 710 is attached to MR 720, which is in turn attached to MR 721. MR 721 is attached to the local mobility management domain 771, which is further attached to the Internet 770. It is further assumed that the MAP cloud or local mobility management domain 771 has multiple MAPs. It is also assumed that MR 721 receives MAP options from MAP 730 and MAP 731 via a RA. Such a received RA packet can be as shown by 781. It is further assumed that MR 721 uses MAP 731 option to configure its RCoA and makes a local registration at MAP 731. BCE 762 shows the binding cache of MAP 731. The said local registration made at MAP 731 is given by the first row of entries in BCE 762. Next, MR 721 broadcasts its RA 782. This RA 782 will possibly have a packet structure as given by 780. It is further assumed that MR 720 will receive this RA and probably use MAP 731 to configure its RCoA. Once MR 720 derives its LCoA and RCoA, it will make local registration at MAP 731. This said registration entry is given by second row of entries in BCE 762. After such local registration, MR 720 may send out its RA 783. This will have the same form as that given by 780. It is assumed that VMN 710 will process MAP 730 option and send its local registration to MAP 730. In this embodiment, global registrations made at home agents are not explicitly explained. Nevertheless, one skilled in the art should readily understand this.

When VMN 710 performs local registration at MAP 730, the entry created at MAP 730 is given by BCE 761. It is further assumed that VMN 710 is having a local mobility management based RO with CN 750. Thus, it is assumed that VMN 710 will perform RR and MIPv6 BU with CN 750 using RCoA as its care-of address. The BCE at CN 750 is given by BCE 760.

It is considered in this embodiment that an arbitrary MAP in MAP cloud 771 has no special functionality to find out whether its binding cache entries are adequate or which MAPs to query to get the relevant entries. It is further considered that every MAP knows all other MAPs in the domain. Henceforth, in this method, new or renewed binding cache entries are sent to every other MAP in the domain by every single MAP. This flooding of BCE transfers is shown by signaling message 786. After such transfer 786, all the MAPs binding cache entries will be same. It can be readily understood that after transfer 786, BCE 761 will definitely have all entries of MR 720 and MR 721. In such a case, it is clear to one skilled in the art that RCoA of VMN 710 can be fully traced at MAP 730. Nevertheless, it is also clear that this method creates unnecessary duplicate permanent entries in the MAPs until the nodes are roaming in the domain (the domain itself can be big and house many MNs and MRs). This is the drawback of this method. When CN 750 sends its data packet to VMN 710 it will be intercepted by MAP 730 and encapsulated in a single tunnel to VMN 710. The route optimized data path from VMN 710 to CN 750 is shown by path segments 784 and 785 in FIG. 7.

In yet another preferred embodiment of the present invention, a slight variation of the method disclosed via FIG. 7 is explained. Any MAP in the MAP cloud 771 will initially have all the RCoA entries of all the MAPs in the MAP domain. It is further considered that any MAP uses a functionality whereby it can identify and categorize its binding cache entries that are used for tunneling a RCoA and moreover find out the MAPs that passed these identified entries. For entries that are not used or never used, the MAP can possibly request the MAPs that transferred such unused entries not to transfer any entries for some period of time. The MAP needs to monitor which entries are passed by which MAPs to make such request signaling. The MAP can monitor which MAPs sent the unused entries by monitoring the source address of message 786.

In another preferred embodiment of the present invention, a method is disclosed where MNs and MRs in the nested NEMO tree path choose one out of n MAPs available and make a registration at the selected MAP. In this current embodiment, it is considered that flooding of BCEs among MAPs as disclosed in FIG. 7 does not take place but the MAPs will monitor which MAP entries are required by inspecting the source address of the packet that is processed at the MAP. When a MAP has inadequate entries to find the LCoAs associated with a RCoA derived from it, packets will reach the said MAP from other MAP (ping-pong between MAPs). It is further considered that when a packet reaches the said MAP from another MAP, the said MAP will query the other MAP to send its registration entries to the current MAP. This way the said MAP can get all the relevant entries to trace a RCoA derived from it and hence eliminate the ping-pong sub-optimal routing between MAPs. Using the method outlined in this current embodiment, said sub-optimal routing could be removed without making permanent duplicate registration as disclosed via FIG. 7. In an alternate way, the MRs can select a MAP and further inform its selection via RA. When lower stream MRs in nested NEMO tree path receive this information, it can find out the upstream MRs MAPs and send this information (up stream MRs MAP addresses) to its own MAP. The said lower stream MR's MAP can possibly query upstream MRs MAPs to pass their entries (since it knows the MAP addresses). This way the ping-pong sub-optimal routing between MAPs is eliminated.

Until now the main inventions and its variations were explained to eliminate route sub-optimality problem in nested NEMO in a multi-MAP scenario. From the two main methods given in the embodiments, it is clear that the first approach is a duplicate registration at another MAP but originated from the terminal (MR) where as the second approach is duplicate registration by transfers are done in the network domain. Next we will look at some scenarios where such kind of duplicate registrations are useful to solve certain problems in alternate scenarios.

Currently in local mobility management, lot of focus is on the NetLMM domain. In NetLMM domain, the local mobility management signaling is done fully via fixed network links and the roaming MN/MR is not aware of its care-of address change nor it is aware that it is moving in a NetLMM domain. In such domains, for load balancing, it is common to deploy multiple local mobility anchors (LMAs). In an alternate domain called the Proxy Mobile IPv6 domain as disclosed in [Non Patent Citation 7], Proxy Mobility Anchor (PMA) sends Proxy MIPv6 signaling on behalf of a roaming MN/MR/IPv6 Host to Proxy Home Agent (PHA). In such a Proxy MIPv6 domain as well, multiple Proxy Home Agents can be deployed for load balancing purposes. Proxy Mobile IPv6 domain is a domain similar to NetLMM domain but, mainly targeted to extend mobility services to IPv6 hosts that are roaming in their home domain. Next we will explore, how such duplicate location registration originated from a MR and MAP-to-MAP transfer of locations registrations disclosed in previous embodiments is useful to solve some issues in NetLMM and Proxy MIPv6 domains.

In the forthcoming embodiments, in the NetLMM domain, it is assumed that the MAG functionality, which is usually implemented in an AR, does the location management signaling on-behalf of the MN. This MAG functionality as disclosed in the [Non Patent Citation 6] can also be centrally located at a PMIP Client. In such a case, the PMIP client sends the local BU to the LMA and binds the MN identifier or care-of address of MN to the address of the AR (the said MN is currently attached to). It can be well understood by one skilled in the art that the above said local BU can also be sent by an AR with PMIP client functionality. In the Proxy MIPv6 domain as disclosed in [Non Patent Citation 7], the MAG functionality can be located at the Proxy MIPv6 Agent. Here, the said agent does proxy registration at the proxy home agent. This said proxy home agent is similar to the LMA in the NetLMM domain.

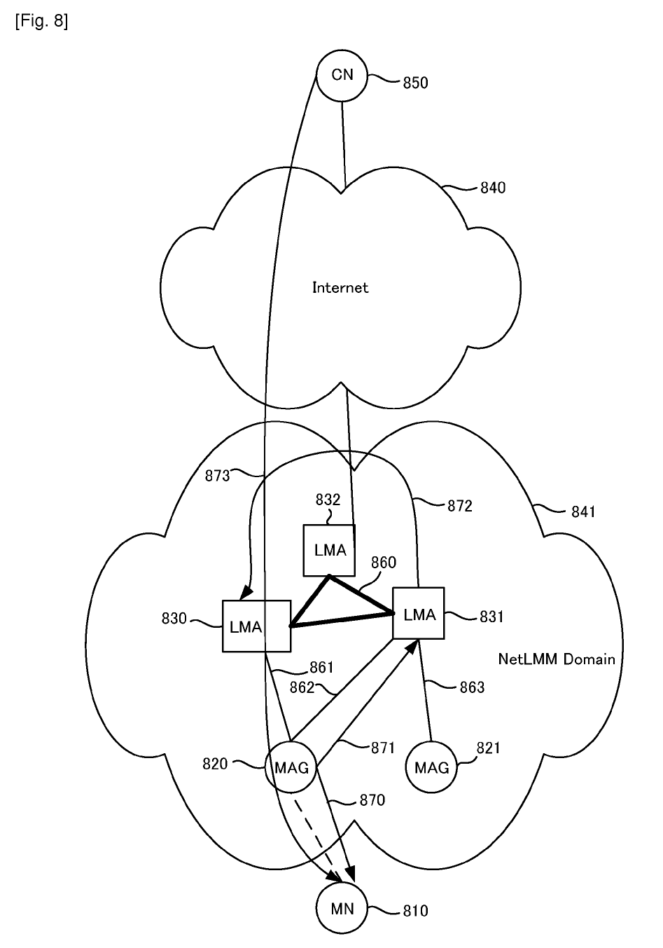

In another preferred embodiment of the present invention, a method where LMA to LMA location entry transfer is revealed for load balancing purpose. This is further elaborated via FIG. 8. In FIG. 8, MN 810 is roaming in a NetLMM Domain 841. It is further assumed that the NetLMM domain 841 is further connected to the Internet 840. MN 810 is currently directly attached to Mobility Access Gateway (MAG) 820, which is an AR with some special functionality so that the roaming MN 810 does not know the link change or sub-network change. It is further considered that NetLMM domain 841 has LMA 830, LMA 831 and LMA 832 in its architecture and all these LMAs are connected by fixed links 860. It is also assumed that MAG 820 is directly connected to LMA 830 and LMA 831 via fixed links 861 and 862 respectively and MAG 821 is connected to LMA 831 via fixed link 863. It is further considered that MAG 820 receive prefixes from both LMA 830 and LMA 831 but decide to choose prefix from LMA 831 to send out in its RA 870. In this case, MN 810 will configure care-of address from prefix of LMA 831. It is further assumed that MAG 820 performs local registration at LMA 831 and this is shown by 871 in FIG. 8. This said registration will bind care-of address of MN 810 to the address of MAG 820.

In such a scenario, LMA 831 may have some information on the usage of LMA 830 and may understand that it is not used much. Some database may preferably be queried to get this information. In such a case, LMA 831 could possibly transfer some of its entries (for load balancing purpose), including entries originated from MAG 820, to LMA 830. This said transfer is shown by message 872 in FIG. 8. The above-mentioned transfer can be a full transfer where LMA 831 deletes its entries and makes a transfer or keeps a copy of the entries and then transfers. It is further assumed that the security key associated with MAG 820 and LMA 831 for MN 810 association is also transferred to LMA 830. In this case, it is further considered that LMA 830 may have to inject some routes to capture the packets being sent to LMA 831 or if it is in the default path can inspect packets coming to the transferred address and then tunnel those packets to MAG 820. If packets captured are not of interest to LMA 830 (destination address is not equal to transferred entries) then the packet will be routed to LMA 831. This can be easily understood by one skilled in the art.

It is also assumed that MN 810 has done MIPv6 registration at its CN 850. When CN 850 sends data packet to MN 810, it will set the destination address to value that is derived from prefix of LMA 831. Nevertheless, LMA 830 will capture this data packet and will encapsulate the packet in a tunnel to MAG 820. MAG 820—will decapsulate this data packet and pass the packet to MN 810. It is important to appreciate that by means of duplicate entries made at both LMA 831 and LMA 830 via the fixed NetLMM links, load balancing is achieved and moreover LMA 831 need not do any tunneling for the numerous data packets and thus can reduce its processing load. The above said data packet routing path after the LMA 831 to LMA 830 transfer is given by 873 in FIG. 8.

In FIG. 8, the NetLMM domain can well be a Proxy MIPv6 domain, LMAs could possibly be Proxy Home Agents and the MAGs could possibly be PMAs. Thus, it can be easily seen that such LMA to LMA transfer disclosed in this current embodiment can apply for Proxy Home Agent to Proxy Home Agent transfer in the Proxy MIPv6 domain for the same purpose (load balancing among PHAs).

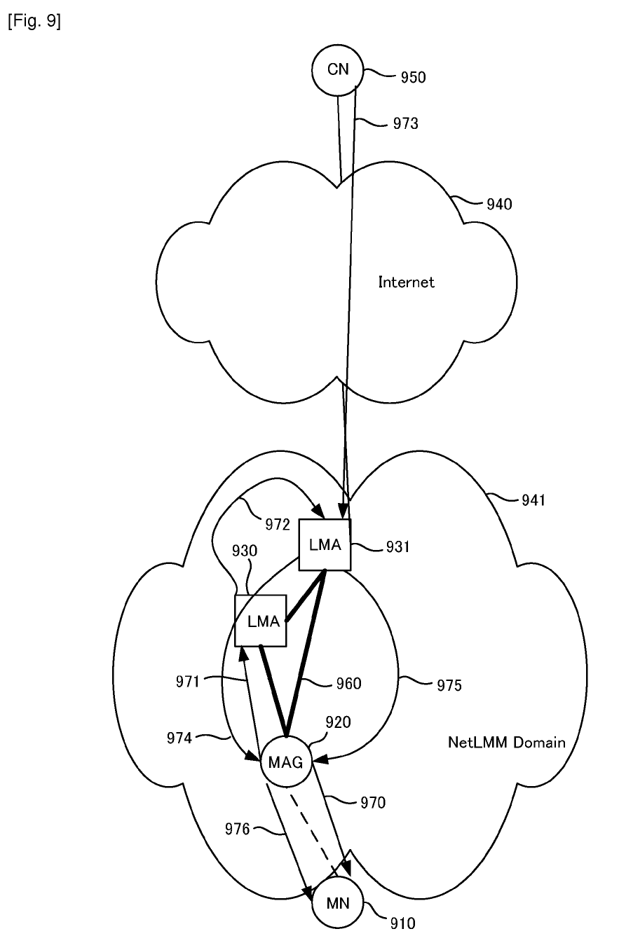

In yet another preferred embodiment of the present invention, duplicate registration at multiple LMAs are made via the NetLMM fixed links for the purpose of increasing reliability of the transfer of highly important data. This duplicate registration is made for bi-casting purpose and it can be well understood by one skilled in the art that bi-casting may be essential to transfer important data when the fixed links in the NetLMM domain is congested. This is further explained via FIG. 9. In FIG. 9, MN 910 is attached to MAG 920 and MAG 920 is directly attached to LMA 930 and LMA 931 via fixed link 960. It is further assumed that MN 910 is having a data communication session with CN 950 and this said data information is highly critical and packet losses should be minimal and timely delivery of data is essential.

In such a scenario, again it is considered that MAG 920 will send prefix of LMA 930 in RA 970. Further, MAG 920 will make a local registration at LMA 930 and this is shown by message 971 in FIG. 9. Some hint (via 971) may be passed to LMA 930 that it needs to transfer the contents associated with MN 910 to LMA 931 for reliability, so that bi-casting of data traffic can be achieved. Thus LMA 930 will make such a transfer or duplicate registration and this is shown by message 972. LMA 930 will still maintain its entries after doing transfer to LMA 931 so that bi-casting can be achieved.

When CN 950 sends its data packet to MN 910, this data packet may reach LMA 931 first because it may be higher up in the routing hierarchy or it may inject routes to get the packet. In either case, LMA 931 will make a duplicate of the packet and further route the packet to LMA 930. Following that, one version of the data packet will be tunneled from LMA 931 to MAG 920 and another version, which was sent to LMA 930, will be tunneled from LMA 930 to MAG 920. This bi casting is shown by 975 and 974 in FIG. 9. MAG 920 will decapsulate the tunneled packets and route it further to MN 910 via 976 where it will be processed by MN 910.

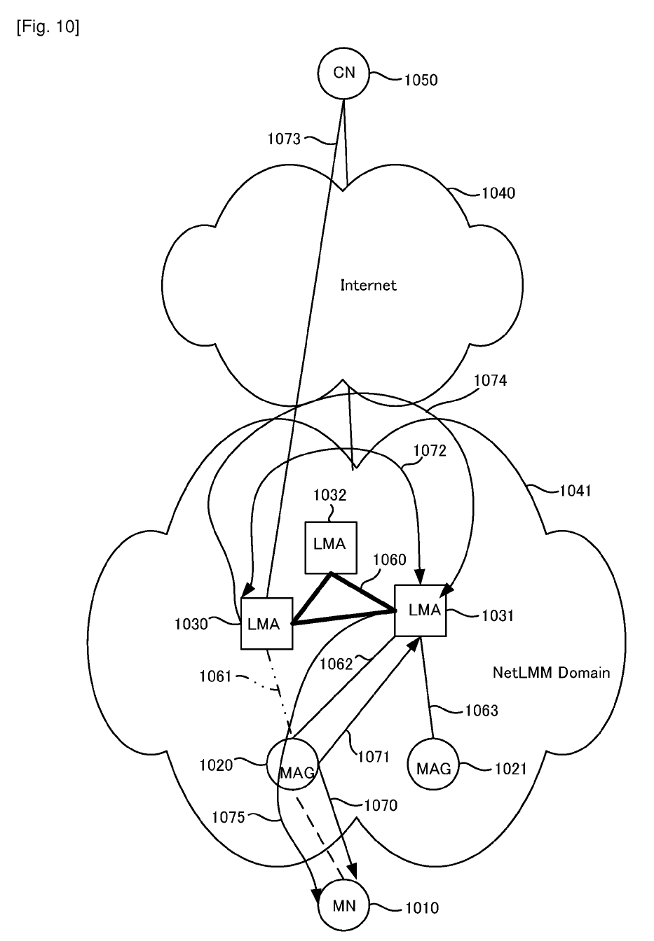

In yet another preferred embodiment of the present invention, duplicate registration at multiple LMAs is done for the purpose of obtaining data packets even if there is a fixed link failure in the NetLMM domain. This method is shown in FIG. 10 and is further explained in the current embodiment. In FIG. 10, MN 1010 is attached to MAG 1020, which is in turn attached to LMA 1030 and LMA 1031 via fixed links 1061 and 1062 respectively. There are three LMAs in the NetLMM domain 1041 and they are LMA 1030, LMA 1031 and LMA 1032. These LMAs are all interconnected by fixed link 1060.

It is assumed that MAG 1020 sends the prefix of LMA 1030 in its RA 1070 and MN 1010 configures its care-of address using the prefix of LMA 1030. Following that, MAG 1020 will make its local registration on-behalf of MN 1010 at LMA 1030. After some time, it is assumed that MAG 1020 stops getting packets from the link 1061 (due to broken link or congestion). MAG hence decides to continue using the prefix of LMA 1030 in its RA but make its local registration at LMA 1030 via LMA 1031. MAG 1020 may get a hint from L2 that the link 1061 is broken or congested and may decide to use this alternate method. Thus the local registration to LMA 1030 is tunneled via LMA 1031 and this is shown by message 1071 in FIG. 10. LMA 1031 will de-tunnel this said local registration message, and preferably keep a copy of registration parameters, and then, further route the message to LMA 1030. The further routed message is shown by 1072 in FIG. 10. LMA 1030 can carry out DAD for the passed entries and send the local ACK to LMA 1031 and LMA 1031 can possibly pass this to MAG 1020. This message can possibly be tunneled to LMA 1031 to be sent to MAG 1020 or ACK contents can be sent to LMA 1031 and LMA 1031 can construct the local ACK. There are numerous ways of doing this and one skilled in the art can easily deduce this. Basically duplicate registration is done at both LMAs (LMA 1030 and LMA 1031). In the future, for renewal of entries, LMA 1031 need not ask LMA 1030 and can merely send ACKs on behalf of LMA 1030.

In this embodiment, since LMA 1030 is not considered overloaded, it can possibly still receive data packets sent from CN 1050 and it is further considered that LMA 1031 need not inject routes to capture packets that are derived from prefix of LMA 1030.

It is further assumed that MN 1010 does RR and MIPv6 registration at CN 1050. The data packet will reach LMA 1030 and this message is shown by 1073 in FIG. 10. LMA 1030 will set the next hop to LMA 1031 and tunnel the data packet and this message is shown by 1074. LMA 1031 will de-tunnel and send the packet to MAG 1020. It can be readily understood that since LMA 1031 has entries associated with MN 1010 it can use its BC entries to tunnel the packet. Thus, even in a broken or congested link scenario, by maintaining duplicate entries, packets can still be received by MN 1010.

Although the invention has been herein shown and described in what is conceived to be the most practical and preferred embodiment, it will be appreciated by those skilled in the art that various modifications may be made in details of design and parameters without departing from the scope and ambit of the invention. For instance, the present invention uses ARO scheme as the route optimization mechanism used in nested mobile networks. It should be appreciated by a person skilled in the art that the present invention could be applied to other route optimization mechanism as well, such as one that uses mobile router's address in some way to achieve route optimization. In addition, the present invention uses HMIPv6 as the local mobility management protocol. It should be appreciated by a person skilled in the art that the present invention could be applied to other local mobility management protocols as well. Furthermore, this invention talks about roaming in local mobility management domains comprising of MAPs, NetLMM domain comprising of multiple LMAs and Proxy Mobile Iv6 domain comprising of multiple Proxy Home Agents. It should be appreciated by one skilled in the art that the present invention could well be applied in other local mobility management domains comprising of different types of mobility management anchors.

### INDUSTRIAL APPLICABILITY

The present invention has the advantage of providing a useful mechanism in an ARO and HMIPv6 heterogeneous environment, and can be applied to the field of packet-switched communication.

1. A system of communication node comprising VMNs, MRs, MAPs, HAs and CNs wherein the said VMNs and MRs have ARO and some HMIPv6 RO enabled protocols implemented, wherein there are a plurality of MAPs in a local mobility management domain architecture, where the said MAPs have some HMIPv6 RO functionality implemented similar to the said VMNs and MRs, and wherein the MR in nested NEMO will make a registration at the MAP of its down stream MRs and VMNs in a nested NEMO tree path, irrespective of the MAP it is attached to.

2. A system of communication node comprising VMNs, MRs, MAPs, HAs and CNs wherein the said VMNs and MRs have ARO and some HMIPv6 RO enabled protocols implemented, wherein there are a plurality of MAPs in a local mobility management domain architecture, where the said MAPs have some HMIPv6 RO functionality implemented similar to the said VMNs and MRs, and wherein the MR in nested NEMO will have information on all MAP options available to its nested NEMO tree path MNs and MRs and thus attach other MAP addresses in its local binding update to its chosen MAP.

3. A mobile router in which ARO and some HMIPv6 RO enabled protocols are implemented, comprising:
an upstream network interface that is capable to be attached to a network wherein there are a plurality of MAPs in a local mobility management domain architecture, there being a plurality of MAPs in a local mobility management domain architecture and the said MAPs having some HMIPv6 RO functionality implemented similar to the mobile router;
a downstream network interface that is capable to be attached to its down stream MRs and VMNs in a nested NEMO tree path, the said VMNs and MRs having ARO and some HMIPv6 RO enabled protocols implemented; and
a registration unit that makes registration at the MAP of its down stream MRs and VMNs in a nested NEMO tree path, irrespective of the MAP the mobile router is attached to.

4. A mobile router in which ARO and some HMIPv6 RO enabled protocols are implemented, comprising:
an upstream network interface that is capable to be attached to a network wherein there are a plurality of MAPs in a local mobility management domain architecture, there being a plurality of MAPs in a local mobility management domain architecture and the said MAPs having some HMIPv6 RO functionality implemented similar to the mobile router;
an information storing unit that stores information on all MAP options available to its nested NEMO tree path; and
an information attaching unit that attaches other MAP addresses in its local binding update to its chosen MAP.
